(19) United States
(12) Patent Application Publication
(10) Pub. No.: US 2026/0199816 A1
(43) Pub. Date: Jul. 16, 2026

(54) Air Purification System

(71) Applicant: Altoric Fulsom, Rolla, MO (US)

(72) Inventor: Altoric Fulsom, Rolla, MO (US)

(73) Assignee: Altoric Fulsom, Rolla, MO (US)

(21) Appl. No.: 19/017,538

(22) Filed: Jan. 11, 2025

Related U.S. Application Data
(60) Provisional application No. 63/600,409, filed on Nov. 17, 2023.

(51) Int. Cl. B01D 46/00; B01D 39/20; B01D 46/46

(52) U.S. Cl. CPC B01D 46/001; B01D 39/2055; B01D 46/46; B01D 2273/14; B01D 2273/30; B01D 2279/40

(57) ABSTRACT

The air purification system has a cement base, and the main metal base housing of the filter system holds up the upper structure. The base may also have elevator access for workers to use for any repair work easily. Above the main base may be long cylinder connector pieces that connect many stories tall for the air to be cleaned at higher levels. Located at the top of the long cylinder connectors is the air purification system that cleans the entire area. Housed inside may be a jet-like vacuum powered fan that pulls in all the polluted and unfiltered air.

### CROSS-REFERENCE TO RELATED APPLICATIONS

This application is an original Nonprovisional Application and claims benefit to provisional applications No. U.S. 63/600,409 filled on Nov. 17, 2023.

### FEDERALLY SPONSORED RESEARCH AND DEVELOPMENT

Not applicable.

The present invention generally relates to the field of filtration and, more specifically, relates to air filtration.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

Air quality is a very important concern in many countries. Many of the densely populated cities of the world have terrible air quality, which affects the health and/well-being of the population. It is desirable that the air quality be improved by reducing pollution, and also that mankind takes active steps to clean up the present conditions. Nothing thus far has been introduced that will serve to improve air quality on a large scale.

Various attempts have been made to solve the above-mentioned problems, such as those found in U.S. Pat. No. 11,524,254 to Yang et al., This art is representative of air filtration. None of the above inventions and patents, taken either singly or in combination, is seen to describe the invention as claimed.

Ideally, an air purification system should provide efficient and/or effective air filtration yet operate reliably and be manufactured at a modest expense. Thus, a need exists for a reliable air purification system to avoid the above-mentioned problems.

### SUMMARY OF THE INVENTION

In view of the foregoing disadvantages inherent in the known air filtration art, the present invention provides a novel air purification system. The general purpose of the present invention, which will be described subsequently in greater detail, is to provide a means to clean air for human consumption.

The air purification system may include a cement base and/or the main metal base housing of the filter system that holds up the upper structure. The base may possibly also have elevator access for workers to easily use for any repair work. Above the main base may be long cylinder connector pieces that connect many stories tall for the air to be cleaned at higher levels. At the top of the long cylinder connectors is the air purification system that cleans the entire area. Housed inside may be a jet-like vacuum-powered fan that pulls in all the polluted and/or unfiltered air. Behind the fan may be 2 chambers of carbon filters that would clean the polluted air coming in and leaving nothing but the purified air going out the other end. This upper purification system also may swivel in any direction, leaving no area unfiltered.

The present invention holds significant improvements and/or serves as an air purification system. For purposes of summarizing the invention, certain aspects, advantages, and/or novel features of the invention have been described herein. It is to be understood that not all such advantages may necessarily be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention that are believed to be novel are particularly pointed out and/or distinctly claimed in the concluding portion of the specification. These and/or other features, aspects, and/or advantages of the present invention will become better understood with reference to the following drawings and/or detailed descriptions.

An air purification system may be made of a base, a middle support pole, and/or an air purifier. The base may be made of a base-anchor and/or a base-bottom, and/or the middle support pole may be configured to connect the base to the air purifier. The purifier may comprise at least one housing module, at least one filtering unit, at least one air suction unit, and/or at least one swiveling mechanism with up to 360-degrees multidirectional movement capabilities, wherein the air-suction unit/air intake unit may be configured to pull air through the filtering unit for air purification.

In some aspects, the techniques described herein may relate to a base-anchor made of cement.

In some aspects, the techniques described herein may relate to a base-bottom made of metal.

In some aspects, the techniques described herein may relate to a base-bottom comprising elevator access.

In some aspects, the techniques described herein may relate to a middle support pole, which may be made of one or more of the length modulable/adjustable mechanisms by selecting from a telescopic design, segmented pole with screw or snap joints, expandable lattice or scissor mechanism, stackable sections with interlocking mechanism, cable and/or sleeve design, magnetic or clip-on modules, and/or any combination thereof.

In some aspects, the techniques described herein may relate to a system 10 to 600 feet tall.

In some aspects, the techniques described herein may relate to a housing module made of light at any location to make the system visible from a distance aerially, water, and/or land.

In some aspects, the techniques described herein may relate to a housing module may have a sensor to detect wind direction and/or speed; these sensors may be selected from a motorized wind tracker, anemometers, cup anemometers, vane anemometers, hot-wire anemometers, ultrasonic sensors, pressure-based sensors, thermal flow sensors, optical sensors, mechanical sensors, mems sensors (microelectromechanical systems), and/or any combination thereof.

In some aspects, the techniques described herein may relate to a multidirectional swiveling mechanism linked to the housing module's wind sensor and/or configured to move with the wind direction.

In some aspects, the techniques described herein may relate to a system that may incorporate a wind-tracking mechanism (e.g., swiveling base, wind vane, or motorized alignment system) to ensure the air intake faces the prevailing wind.

In some aspects, the techniques described herein may relate to a multidirectional swiveling mechanism that may be lockable and/or unlockable.

In some aspects, the techniques described herein may relate to one or more of the multidirectional swirl mechanisms selected from a rotating platform, omnidirectional swirl device, propeller or nozzle-based device, fan with swiveling head, swivel bearing, rotating bracket, turntable swivel plate, motorized swivels, Swiveling Base with Bearings, etc., and/or any combination of thereof.

In some aspects, the techniques described herein may relate to a housing module that may have one or more of the air suction mechanisms selected from a single-stage high-performance turbine, dual turbines, multi-stage turbine systems (more than two stages), fans, centrifugal blowers, regenerative blowers (ring blowers), positive displacement blowers, axial fans, hybrid cyclonic systems, etc., and/or any combination thereof.

In some aspects, the techniques described herein may relate to a filtering unit configured at the air-suction unit's back end such that the sucked air may be filtered and/or purified.

In some aspects, the techniques described herein may relate to a filtering unit that may be made of at least one carbon filter.

In some aspects, the techniques described herein may relate to a filtering unit may be made of one or more selected from a HEPA filter (high-efficiency particulate air), pre-filters, ULPA filters (ultra-low penetration air), electrostatic filtration, electrostatic precipitators, ionizers, activated carbon filtration, UV-C light purification, photocatalytic oxidation (PCO), ozone generators, biological filtration, biofilters, plasma air purification, thermal oxidation, ozone destructive catalyst, hybrid systems, PreMax Pre-Filter, potassium permanganate impregnated media, 3D UltraSeal Technology, Advanced Fan Technology and/or any combination thereof. Potassium Permanganate Impregnated Media: Neutralizes harmful chemicals through oxidation.

In some aspects, the techniques described herein may relate to a system that may be powered by one or more from a solar power, wind-powered, battery, electricity, generators, wind, etc., and/or any combination thereof.

In some aspects, the techniques described herein may relate to a filtration unit that may one or more types of air-comtaminats, and/or the fiteration and/or purification is from one or more of dust, particles of 0.003 microns, PM10, particles ≤10 microns (e.g., dust, pollen, mold), PM2.5, particles ≤2.5 microns (e.g., smoke, fine dust), PM1 particles ≤1 micron (e.g., viruses, ultrafine pollutants), allergens, pollen, pet dander, mold spores, dust mites, biological contaminates, viruses (e.g., influenza, SARS-COV-2), bacteria (e.g., Legionella), mold and/or fungi, gaseous pollutants, volatile organic compounds (VOCs), emitted by paints, solvents, cleaning agents, and/or building materials, carbon monoxide (CO), from incomplete combustion of fuel, nitrogen dioxide (NO₂), emitted from vehicles and/or industrial processes, sulfur dioxide (SO₂), produced by burning fossil fuels, smoke odor, cooking smells, pet odors, smoke and/or soot, chemical pollutants, formaldehyde (from furniture and/or carpets), ammonia (from cleaning products), chlorine gases, heavy metals, lead, cadmium, mercury (from industrial emissions), radon, ozone, paint emitters, vehicle emitters, industrial emitters, cooking emitters, and/or any combination thereof.

In some aspects, the techniques described herein may relate to a housing module that may have a sieving mechanism to be configured to prevent birds and/or other large materials from entering the purification unit.

In some aspects, the techniques described herein may relate to a housing module that may be dome-shaped, which may protect the housing module contents from elements such as tornadoes, high winds, and/or other environmental elements.

In some aspects, the techniques described herein may relate to a housing module may have a sensor to detect wind direction and/or speed; these sensors may be selected from a motorized wind tracker, anemometers, cup anemometers, vane anemometers, hot-wire anemometers, ultrasonic sensors, pressure-based sensors, thermal flow sensors, optical sensors, mechanical sensors, MEMS (Micro-Electro-Mechanical) sensors, wind profiler, radar or acoustic signals to provide a vertical profile of wind flow and/or direction, thermal anemometers, multi-hole probes, doppler radar, LIDAR (Light Detection and/or Ranging) systems, pitot tubes, motion sensors, tilt sensors, and/or any combination thereof.

In some aspects, the techniques described herein may relate to a system configured to be controlled by a customizable and/or programmable control panel. The control panel location is selected from one or more selected from a base, the middle support pole, the air purifier, remotely, an APP, and/or any combination thereof.

In some aspects, the techniques described herein may relate to the control panel may control the middle pole height, functions of suction units, and/or filtering units, such as suction levels, filtration levels and/or type, the swivel mechanism, suction, and/or any combination thereof.

In some aspects, the techniques described herein may relate to the control panel is configured to regulate one or more system parts, the control panel is configured to regulate one or more selected from a middle pole height, suction levels, filtration levels, filtration type, the swivel mechanism, swivel direction, swivel amount, air suction, and/or any combination thereof.

In some aspects, the techniques described herein may relate to system filter units, which may cover up to 2000 square feet, wherein the filter units are square, circular, oval, rectangular, triangular, semi-circular, 5-, 6-, 7-, 8-, 9-, 10-sided shapes, etc., and/or any combination thereof.

In some aspects, the techniques described herein may relate to a building fixable system such that it is mounted and/or attached to at least one building.

In some aspects, the techniques described herein may relate to one or more parts of the housing module that may be detachably attached. One or more parts of housing modules may be replaced manually and/or automatically, etc., and/or any combination thereof.

In some aspects, the techniques described herein may relate to one or more parts of the housing module comprising at least one or more lights.

In some aspects, the techniques described herein may relate to the purifier filtering air from 11,000 to 350,000 cubic feet per hour.

### BRIEF DESCRIPTION OF FIGURES AND DRAWINGS

The figures that accompany the written portion of this specification illustrate embodiments and method(s) of use for the present invention, the air purification system, and/or how it is constructed and operative according to the teachings of the present invention.

FIG. 1 shows a front view illustrating an air purification system according to an embodiment of the present invention.

FIG. 2. is a side view illustrating the air purification system according to an embodiment of the present invention of FIG. 1.

FIG. 3 is a front view illustrating the air purification system according to an embodiment of the present invention of FIG. 1.

FIG. 4. is a perspective view illustrating the air purification system according to an embodiment of the present invention of FIG. 1.

FIG. 5 is a side view illustrating the air purification housing with the swiveling platform with a 360-degree multidirectional movement mechanism according to an embodiment of the present invention of FIG. 1.

FIG. 6 is a side view illustrating the air purification system attached to a building according to an embodiment of the present invention of FIG. 1.

FIG. 7 is a side view illustrating the air purification system mounted on top of a building according to an embodiment of the present invention of FIG. 1.

The various embodiments of the present invention will hereinafter be described in conjunction with the appended drawings, wherein like designations denote like elements.

### DETAILED DESCRIPTION OF THE INVENTION

Examples of embodiments are provided so that this disclosure will be thorough and fully convey the scope to those skilled in the art. Numerous specific details are set forth, such as examples of specific components, devices, and methods, to provide a thorough understanding of the embodiments of the present disclosure. It will be apparent to those skilled in the art that specific details need not be employed, that example embodiments may be embodied in many different forms, and that neither should be construed to limit the scope of the disclosure. In some examples, embodiments, aspects, well-known processes, well-known device structures, and well-known technologies are not described in detail least one specification heading is required.

The terminology used herein is for the purpose of describing particular example embodiments only and is not intended to be limiting. As used herein, the singular forms “a,” “an,” and “the” may be intended to include the plural forms as well unless the context clearly indicates otherwise. The terms “comprises,” “comprising,” “including,” and/or “having,” are inclusive and therefore specify the presence of stated features, integers, steps, operations, elements, and/or components but do not preclude the presence or addition of one or more other features, integers, steps, operations, elements, components, and groups thereof. The method steps, processes, and operations described herein are not to be construed as necessarily requiring their performance in the particular order discussed or illustrated unless specifically identified as an order of performance. It is also to be understood that additional or alternative steps may be employed.

The preceding summary, as well as the following detailed description of certain embodiments, will be better understood when read in conjunction with the appended figure of experimental data and results. As used herein, an element or step recited in the singular and proceeded with the word “a” or “an” should be understood as not excluding the plural of said elements or steps unless such exclusion is explicitly stated. Furthermore, references to “one embodiment” or “an embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property. When a definition is provided herein, it supersedes any other meaning or definition.

As discussed above, embodiments of the present invention relate to air filtration and, more particularly, to an air purification system used to improve the filtration of air.

The air purification system, in certain embodiments, may stand many stories tall, starting on a cement base for stability. On top of that, the cement base may be the main metal base housing of the filter system that holds up the upper structure. The base may possibly also have elevator access for workers to easily use for any repair work. Above the main base may be long cylinder connector pieces that connect many stories tall for the air to be cleaned at higher levels. At the top of the long cylinder connectors is the air purification system that cleans the entire area. Housed inside may be a jet-like vacuum-powered fan that pulls in all the polluted and unfiltered air. Behind the fan may be 2 chambers of carbon filters that would clean the polluted air coming in and leaving nothing but the purified air going out the other end. This upper purification system also may swivel in any direction, leaving no area untouched.

An air purification system may be made of a base, a middle support pole, and/or an air purifier. The base may be made of a base-anchor and/or a base-bottom, and/or the middle support pole may be configured to connect the base to the air purifier. The purifier may comprise at least one housing module, at least one filtering unit, at least one air suction unit, and/or at least one swiveling mechanism with up to 360-degree multidirectional movement capabilities, wherein the air-suction unit may be configured to pull air through the filtering units for air purification.

In some aspects, the techniques described herein may relate to the swivel mechanism capable of up tp 360-degree movement, for example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 291, 292, 293, 294, 295, 296, 297, 298, 299, 300, 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 348, 349, 350, 351, 352, 353, 354, 355, 356, 357, 358, 359, 360 degrees, and/or any combination thereof.

In some aspects, the techniques described herein may relate to a housing module that may have a modular design that may allow easy replacement and/or servicing of filters.

In some aspects, the techniques described herein may relate to a base-anchor made of cement, stainless steel, aluminum, powder-coated steel, polycarbonate, UV-resistant plastic, Teflon coating, and/or any combination thereof.

In some aspects, the techniques described herein may relate to a base-bottom made of metal, stainless steel, aluminum, powder-coated steel, polycarbonate, UV-resistant plastic, Teflon coating, and/or any combination thereof.

In some aspects, the techniques described herein may relate to a middle support pole, which may be made of metal, stainless steel, aluminum, powder-coated steel, polycarbonate, UV-resistant plastic, Teflon-coating, and/or any combination thereof.

In some aspects, the techniques described herein may relate to a housing module and/or parts thereof may be made of metal, stainless steel, aluminum, powder-coated steel, polycarbonate, UV-resistant plastic, Teflon coating, and/or any combination thereof.

In some aspects, the techniques described herein may relate to a base-bottom comprising one or more elevator access and/or staircases, for example, 1, 2, 3, 4, 5, 6, 7, 8, 9, 10 elevators, and/or staircases, and/or any combination thereof.

In some aspects, the techniques described herein may relate to a middle support pole, which may be made of one or more of the length modulable/adjustable mechanisms by selecting from a telescopic design, segmented pole with screw or snap joints, expandable lattice, scissor mechanism, stackable sections with interlocking mechanism, cable and/or sleeve design, magnetic or clip-on modules, and/or any combination thereof.

In some aspects, the techniques described herein may relate to a housing module made of light at any location to make the system visible from a distance aerially, water, and/or land.

In some aspects, the techniques described herein may relate to a housing module may have a sensor to detect wind direction and/or speed; these sensors may be selected from a motorized wind trackers, anemometers, cup anemometers, vane anemometers, hot-wire anemometers, ultrasonic sensors, pressure-based sensors, thermal flow sensors, optical sensors, mechanical sensors, MEMS (Micro-Electro-Mechanical) sensors, wind profiler, radar or acoustic signals to provide a vertical profile of wind flow and/or direction, thermal anemometers, multi-hole probes, doppler radar, LIDAR (Light Detection and/or Ranging) systems, pitot tubes, motion sensors, tilt sensors, and/or any combination thereof.

In some aspects, the techniques described herein may relate to a multidirectional swiveling mechanism linked to the housing module's wind sensor and/or configured to move with the wind direction.

In some aspects, the techniques described herein may relate to a system that may incorporate a wind-tracking mechanism configured to ensure the air intake faces the prevailing wind direction.

In some aspects, the techniques described herein may relate to the wind-tracking mechanism, which may be one or more from a swiveling base, wind vane, motorized alignment system, and/or any combination thereof. This mechanism may ensure the air intake or air sucked in faces the prevailing wind.

In some aspects, the techniques described herein may relate to a system that may have an air suction unit mechanism that may include an air-intake component and an air-pushed-out component.

In some aspects, the techniques described herein may relate to a system that may have an air suction unit mechanism for maximum airflow capture from the environment by the use of a unique design that may incorporate a wind-vane alignment mechanism into the air purifier and/or any component of it to ensure the intake faces the prevailing wind.

In some aspects, the techniques described herein may relate to a system may have an air suction unit mechanism that may integrate a wide intake funnel shape into the air purifier and/or any component of the air purifier to enhance airflow capture and/or direct the air efficiently towards the filters. The air-pushed-out may also be part of this air purifier's enhanced airflow to capture and/or direct the air efficiently out of the system and away from the filters.

In some aspects, the techniques described herein may relate to an intake funnel, and/or other parts of the air suction unit may be made of high-density polyethylene (HDPE), which may provide the required lightweight and/or weather resistance.

In some aspects, the techniques described herein may relate to the air purifier that may have a protective mesh/grille that may prevent debris, rain, snow, dust, birds, insects, leaves, large debris, etc., from entering the purifier and/or any part thereof.

In some aspects, the techniques described herein may relate to the protective mesh/grille, which may be made of metal, stainless steel, aluminum, powder-coated steel, polycarbonate, UV-resistant plastic, Teflon-coating, and/or any combination thereof.

In some aspects, the techniques described herein may relate to the air purifier that may have a protective mesh/grille that may work with or with diverters.

In some aspects, the techniques described herein may relate to the air purifier that may have protective diverts to protect from debris, rain, snow, dust, birds, insects, leaves, etc., and/or any combination thereof.

In some aspects, the techniques described herein may relate to the diverters that may be made of HDPE, rubber, flexible materials, metal, stainless steel, aluminum, powder-coated steel, polycarbonate, UV-resistant plastic, Teflon-coating, and/or any combination thereof.

In some aspects, the techniques described herein may relate to a multidirectional swiveling mechanism that may be lockable and/or unlockable.

In some aspects, the techniques described herein may relate to a system 10 to 1000 feet tall, for example, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 291, 292, 293, 294, 295, 296, 297, 298, 299, 300, 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 348, 349, 350, 351, 352, 353, 354, 355, 356, 357, 358, 359, 360, 361, 362, 363, 364, 365, 366, 367, 368, 369, 370, 371, 372, 373, 374, 375, 376, 377, 378, 379, 380, 381, 382, 383, 384, 385, 386, 387, 388, 389, 390, 391, 392, 393, 394, 395, 396, 397, 398, 399, 400, 401, 402, 403, 404, 405, 406, 407, 408, 409, 410, 411, 412, 413, 414, 415, 416, 417, 418, 419, 420, 421, 422, 423, 424, 425, 426, 427, 428, 429, 430, 431, 432, 433, 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 501, 502, 503, 504, 505, 506, 507, 508, 509, 510, 511, 512, 513, 514, 515, 516, 517, 518, 519, 520, 521, 522, 523, 524, 525, 526, 527, 528, 529, 530, 531, 532, 533, 534, 535, 536, 537, 538, 539, 540, 541, 542, 543, 544, 545, 546, 547, 548, 549, 550, 551, 552, 553, 554, 555, 556, 557, 558, 559, 560, 561, 562, 563, 564, 565, 566, 567, 568, 569, 570, 571, 572, 573, 574, 575, 576, 577, 578, 579, 580, 581, 582, 583, 584, 585, 586, 587, 588, 589, 590, 591, 592, 593, 594, 595, 596, 597, 598, 599, 600, 601, 602, 603, 604, 605, 606, 607, 608, 609, 610, 611, 612, 613, 614, 615, 616, 617, 618, 619, 620, 621, 622, 623, 624, 625, 626, 627, 628, 629, 630, 631, 632, 633, 634, 635, 636, 637, 638, 639, 640, 641, 642, 643, 644, 645, 646, 647, 648, 649, 650, 651, 652, 653, 654, 655, 656, 657, 658, 659, 660, 661, 662, 663, 664, 665, 666, 667, 668, 669, 670, 671, 672, 673, 674, 675, 676, 677, 678, 679, 680, 681, 682, 683, 684, 685, 686, 687, 688, 689, 690, 691, 692, 693, 694, 695, 696, 697, 698, 699, 700, 701, 702, 703, 704, 705, 706, 707, 708, 709, 710, 711, 712, 713, 714, 715, 716, 717, 718, 719, 720, 721, 722, 723, 724, 725, 726, 727, 728, 729, 730, 731, 732, 733, 734, 735, 736, 737, 738, 739, 740, 741, 742, 743, 744, 745, 746, 747, 748, 749, 750, 751, 752, 753, 754, 755, 756, 757, 758, 759, 760, 761, 762, 763, 764, 765, 766, 767, 768, 769, 770, 771, 772, 773, 774, 775, 776, 777, 778, 779, 780, 781, 782, 783, 784, 785, 786, 787, 788, 789, 790, 791, 792, 793, 794, 795, 796, 797, 798, 799, 800, 801, 802, 803, 804, 805, 806, 807, 808, 809, 810, 811, 812, 813, 814, 815, 816, 817, 818, 819, 820, 821, 822, 823, 824, 825, 826, 827, 828, 829, 830, 831, 832, 833, 834, 835, 836, 837, 838, 839, 840, 841, 842, 843, 844, 845, 846, 847, 848, 849, 850, 851, 852, 853, 854, 855, 856, 857, 858, 859, 860, 861, 862, 863, 864, 865, 866, 867, 868, 869, 870, 871, 872, 873, 874, 875, 876, 877, 878, 879, 880, 881, 882, 883, 884, 885, 886, 887, 888, 889, 890, 891, 892, 893, 894, 895, 896, 897, 898, 899, 900, 901, 902, 903, 904, 905, 906, 907, 908, 909, 910, 911, 912, 913, 914, 915, 916, 917, 918, 919, 920, 921, 922, 923, 924, 925, 926, 927, 928, 929, 930, 931, 932, 933, 934, 935, 936, 937, 938, 939, 940, 941, 942, 943, 944, 945, 946, 947, 948, 949, 950, 951, 952, 953, 954, 955, 956, 957, 958, 959, 960, 961, 962, 963, 964, 965, 966, 967, 968, 969, 970, 971, 972, 973, 974, 975, 976, 977, 978, 979, 980, 981, 982, 983, 984, 985, 986, 987, 988, 989, 990, 991, 992, 993, 994, 995, 996, 997, 998, 999, 1000 feet and/or any combination thereof.

In some aspects, the techniques described herein may relate to at least one swiveling platform with the 360-degree multidirectional movement mechanism such as a rotating platform, omnidirectional swirl device, propeller and/or nozzle-based device, swiveling head, fan with swiveling head, swivel bearing, rotating bracket, turntable swivel plate, motorized swivels, swiveling base with bearings, stainless steel bearings, etc., and/or any combination of thereof.

In some aspects, the techniques described herein may relate to the multidirectional swivel/rotating mechanism that may align the system with wind direction for airflow capture.

In some aspects, the techniques described herein may relate to the multidirectional swivel/rotating mechanism that may mount one or more wind vanes on the top of the air purifier, housing module, and/or filter unit to detect wind direction.

In some aspects, the techniques described herein may relate to the multidirectional swivel/rotating mechanism that may have one or more motorized alignment units for actively tracking wind speed and/or direction changes.

In some aspects, the techniques described herein may relate to the multidirectional swivel/rotating mechanism that may have one or more swiveling bases mounting on heavy-duty bearings for smooth rotation.

In some aspects, the techniques described herein may relate to a housing module that may have one or more of the air suction mechanisms selected from a single-stage high-performance turbine, dual turbines, multi-stage turbine systems (more than two stages), multi-stage turbine systems with more than two stages, fans, centrifugal blowers, regenerative blowers, ring blowers, positive displacement blowers, axial fans, hybrid cyclonic systems, brushless DC motors, etc., and/or any combination thereof.

In some aspects, the techniques described herein may relate to the air-suction mechanisms that may have regulatable and/or customizable airflow and/or pressure capabilities.

In some aspects, the techniques described herein may relate to the air-suction units/mechanisms that may be made of metal, stainless steel, aluminum, powder-coated steel, polycarbonate, UV-resistant plastic, Teflon-coating, and/or any combination thereof.

In some aspects, the techniques described herein may relate to a filtering unit configured at the air-suction unit's back end (behind the air-in-take component/s) such that the sucked air may be filtered and/or purified and then pushed out.

In some aspects, the techniques described herein may relate to a filtering unit that may be made of at least one carbon filter, for example, 1, 2, 3, 4, 5, 6, 7, 8, 9, 10, 12, 13, 14, 15, 16, 17, 18, 19, 20, and/or any combination thereof.

In some aspects, the techniques described herein may relate to a filtering unit made of at least two combined filters, pre-filters, HEPA filters, and/or activated carbon to ensure the comprehensive removal of particulates, gases, and/or/or both, for example, 1, 2, 3, 4, 5, 6, 7, 8, 9, 10, 12, 13, 14, 15, 16, 17, 18, 19, 20, and/or any combination thereof.

In some aspects, the techniques described herein may relate to a filtering unit may be made of one or more selected from a HEPA filter (high-efficiency particulate air), pre-filters, ULPA filters (ultra-low penetration air), electrostatic filtration, electrostatic precipitators, ionizers, activated carbon filtration, UV-C light purification, photocatalytic oxidation (PCO), ozone generators, biological filtration, biofilters, plasma air purification, thermal oxidation, ozone destructive catalyst, hybrid systems, PreMax Pre-Filter, potassium permanganate impregnated media, 3D UltraSeal Technology, Advanced Fan Technology and/or any combination thereof.

In some aspects, the techniques described herein may relate to a filtering unit that may have potassium permanganate-impregnated media that may neutralize harmful chemicals through oxidation.

In some aspects, the techniques described herein may relate to a filtering unit made of at least two combined filters selected from activated carbon, HEPA filters (high-efficiency particulate air), pre-filters, ULPA filters (ultra-low penetration air), electrostatic filtration, electrostatic precipitators, ionizers, activated carbon filtration, UV-C light purification, photocatalytic oxidation (PCO), ozone generators, biological filtration, biofilters, plasma air purification, thermal oxidation, ozone destructive catalyst, hybrid systems, PreMax Pre-Filter, potassium permanganate impregnated media, 3D UltraSeal Technology, Advanced Fan Technology and/or any combination thereof.

In some aspects, the techniques described herein may relate to a filtering unit that may be made of hydrophobic carbon filters; the filtering unit may be wholly or partially coated with a hydrophobic coating to make them weatherproof and/or resistant.

In some aspects, the techniques described herein may relate to one or more parts of the system, such as a base, middle support pole, air purifier, housing module, filtering unit, air suction unit, swiveling platform with up to 360-degree multidirectional movement mechanism, parts thereof, and/or any combination thereof that may be made of hydrophobic carbon coating wholly or partially coated to make them weatherproof and/or resistant.

In some aspects, the techniques described herein may relate to one or more parts of the system, such as a base, middle support pole, air purifier, housing module, filtering unit, air suction unit, swiveling platform with up to 360-degree multidirectional movement mechanism, and/or any combination thereof may be sealed to prevent saturation from moisture.

In some aspects, the techniques described herein may relate to a housing module and/or parts thereof that may be coated with a hydrophobic coating for weatherproofing and/or resistance.

In some aspects, the techniques described herein may relate to a housing module and/or parts thereof that may be configured to protect internal components from weather, debris, and/or wear.

In some aspects, the techniques described herein may relate to the system and/or any parts thereof that may have a weatherproof enclosure that shields internal components from rain, UV radiation, extreme temperatures, environmental elements, etc., and/or any combination thereof.

In some aspects, the techniques described herein may relate to a system that may be powered by one or more from a solar power, monocrystalline solar panel, battery, lithium-ion battery, electricity, backup battery, generator, wind power, etc., and/or any combination thereof.

In some aspects, the techniques described herein may relate to a filtration unit that may remove (remove or neutralize) one or more types of air-comtaminats to filter and/or purify air from dust, particles of 0.003 microns, PM10, particles ≤10 microns (e.g., dust, pollen, mold), PM2.5, particles ≤2.5 microns (e.g., smoke, fine dust), PM1 particles ≤1 micron (e.g., viruses, ultrafine pollutants), allergens, pollen, pet dander, mold spores, dust mites, biological contaminates, viruses (e.g., influenza, SARS-COV-2), bacteria (e.g., Legionella), mold and/or fungi, gaseous pollutants, volatile organic compounds (VOCs), emitted by paints, solvents, cleaning agents, and/or building materials, carbon monoxide (CO), from incomplete combustion of fuel, nitrogen dioxide (NO₂), emitted from vehicles and/or industrial processes, sulfur dioxide (SO₂), produced by burning fossil fuels, smoke odor, cooking smells, pet odors, smoke and/or soot, chemical pollutants, formaldehyde (from furniture and/or carpets), ammonia (from cleaning products), chlorine gases, heavy metals, lead, cadmium, mercury (from industrial emissions), radon, ozone, paint emitters, vehicle emitters, industrial emitters, cooking emitters, and/or any combination thereof.

In some aspects, the techniques described herein may relate to a filtration unit that may have up to 99% efficiency; the efficiency may be for particulates such as PM.003, PM2.5, PM1, PM10, gaseous, biological contaminants, chemicals, metals, etc., and/or any combination thereof. For example, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99% efficiency, and/or any combination thereof.

In some aspects, the techniques described herein may relate to a housing module that may have a sieving mechanism to be configured to prevent birds and/or other large materials from entering the purification unit.

In some aspects, the techniques described herein may relate to a housing module that may be dome-shaped, which may protect the housing module contents from elements such as tornadoes, high winds, and/or other environmental elements. This aerodynamic shape may reduce wind resistance, thus allowing better alignment with oncoming airflow.

In some aspects, the techniques described herein may relate to a system configured to be controlled by a customizable and/or programmable control panel, which may be smart. The control panel may be localized at one or more of the base, the middle support pole, the air purifier, remotely, an APP, and/or any combination thereof. The control panel may control, regulate, manage, and/or operate one or more of the middle pole height, functions of the air purifier, housing modules, suction units, and/or filtering units, such as suction levels, filtration levels, filtration type, airflow, the swivel mechanism, and/or any combination thereof, the middle pole height, suction levels, filtration levels, filtration type, the swivel mechanism, swivel direction, swivel amount, air suction, and/or any combination thereof.

In some aspects, the techniques described herein may relate to a control panel that may be controlled to schedule regular maintenance to replace one or more filters before saturation.

In some aspects, the techniques described herein may relate to a control panel that may automate the operations of the system and/or parts thereof.

In some aspects, the techniques described herein may relate to a control panel that may allow for remote and/or local monitoring and/or control of operations of the system and/or parts thereof.

In some aspects, the techniques described herein may relate to a smart control panel that may allow for remote monitoring and/or control of operations of the system and/or parts thereof via a smartphone, computer, laptop, tablet, and/or any smart device.

In some aspects, the techniques described herein may relate to a control panel that may allow for remote monitoring and/or control of operations of the system and/or parts thereof via IoT integration.

In some aspects, the techniques described herein may relate to a control panel that may control real-time monitoring sensors to adjust airflow and/or fan speed (suction unit) based on pollution levels. This adjustment may be manual and/or/or automated.

In some aspects, the techniques described herein may relate to a control panel and/or parts thereof that a protective coating may weatherproof.

In some aspects, the techniques described herein may relate to a control panel with a weatherproof display/touch panel.

In some aspects, the techniques described herein may relate to system filter units, which may cover up to 2500 square feet, wherein the filter units may be square, circular, oval, rectangular, triangular, semi-circular, 5-, 6-, 7-, 8-, 9-, 10-sided shapes, etc., and/or any combination thereof. For example, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 291, 292, 293, 294, 295, 296, 297, 298, 299, 300, 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 348, 349, 350, 351, 352, 353, 354, 355, 356, 357, 358, 359, 360, 361, 362, 363, 364, 365, 366, 367, 368, 369, 370, 371, 372, 373, 374, 375, 376, 377, 378, 379, 380, 381, 382, 383, 384, 385, 386, 387, 388, 389, 390, 391, 392, 393, 394, 395, 396, 397, 398, 399, 400, 401, 402, 403, 404, 405, 406, 407, 408, 409, 410, 411, 412, 413, 414, 415, 416, 417, 418, 419, 420, 421, 422, 423, 424, 425, 426, 427, 428, 429, 430, 431, 432, 433, 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 501, 502, 503, 504, 505, 506, 507, 508, 509, 510, 511, 512, 513, 514, 515, 516, 517, 518, 519, 520, 521, 522, 523, 524, 525, 526, 527, 528, 529, 530, 531, 532, 533, 534, 535, 536, 537, 538, 539, 540, 541, 542, 543, 544, 545, 546, 547, 548, 549, 550, 551, 552, 553, 554, 555, 556, 557, 558, 559, 560, 561, 562, 563, 564, 565, 566, 567, 568, 569, 570, 571, 572, 573, 574, 575, 576, 577, 578, 579, 580, 581, 582, 583, 584, 585, 586, 587, 588, 589, 590, 591, 592, 593, 594, 595, 596, 597, 598, 599, 600, 601, 602, 603, 604, 605, 606, 607, 608, 609, 610, 611, 612, 613, 614, 615, 616, 617, 618, 619, 620, 621, 622, 623, 624, 625, 626, 627, 628, 629, 630, 631, 632, 633, 634, 635, 636, 637, 638, 639, 640, 641, 642, 643, 644, 645, 646, 647, 648, 649, 650, 651, 652, 653, 654, 655, 656, 657, 658, 659, 660, 661, 662, 663, 664, 665, 666, 667, 668, 669, 670, 671, 672, 673, 674, 675, 676, 677, 678, 679, 680, 681, 682, 683, 684, 685, 686, 687, 688, 689, 690, 691, 692, 693, 694, 695, 696, 697, 698, 699, 700, 701, 702, 703, 704, 705, 706, 707, 708, 709, 710, 711, 712, 713, 714, 715, 716, 717, 718, 719, 720, 721, 722, 723, 724, 725, 726, 727, 728, 729, 730, 731, 732, 733, 734, 735, 736, 737, 738, 739, 740, 741, 742, 743, 744, 745, 746, 747, 748, 749, 750, 751, 752, 753, 754, 755, 756, 757, 758, 759, 760, 761, 762, 763, 764, 765, 766, 767, 768, 769, 770, 771, 772, 773, 774, 775, 776, 777, 778, 779, 780, 781, 782, 783, 784, 785, 786, 787, 788, 789, 790, 791, 792, 793, 794, 795, 796, 797, 798, 799, 800, 801, 802, 803, 804, 805, 806, 807, 808, 809, 810, 811, 812, 813, 814, 815, 816, 817, 818, 819, 820, 821, 822, 823, 824, 825, 826, 827, 828, 829, 830, 831, 832, 833, 834, 835, 836, 837, 838, 839, 840, 841, 842, 843, 844, 845, 846, 847, 848, 849, 850, 851, 852, 853, 854, 855, 856, 857, 858, 859, 860, 861, 862, 863, 864, 865, 866, 867, 868, 869, 870, 871, 872, 873, 874, 875, 876, 877, 878, 879, 880, 881, 882, 883, 884, 885, 886, 887, 888, 889, 890, 891, 892, 893, 894, 895, 896, 897, 898, 899, 900, 901, 902, 903, 904, 905, 906, 907, 908, 909, 910, 911, 912, 913, 914, 915, 916, 917, 918, 919, 920, 921, 922, 923, 924, 925, 926, 927, 928, 929, 930, 931, 932, 933, 934, 935, 936, 937, 938, 939, 940, 941, 942, 943, 944, 945, 946, 947, 948, 949, 950, 951, 952, 953, 954, 955, 956, 957, 958, 959, 960, 961, 962, 963, 964, 965, 966, 967, 968, 969, 970, 971, 972, 973, 974, 975, 976, 977, 978, 979, 980, 981, 982, 983, 984, 985, 986, 987, 988, 989, 990, 991, 992, 993, 994, 995, 996, 997, 998, 999, 1000, 1000, 1001, 1002, 1003, 1004, 1005, 1006, 1007, 1008, 1009, 1010, 1011, 1012, 1013, 1014, 1015, 1016, 1017, 1018, 1019, 1020, 1021, 1022, 1023, 1024, 1025, 1026, 1027, 1028, 1029, 1030, 1031, 1032, 1033, 1034, 1035, 1036, 1037, 1038, 1039, 1040, 1041, 1042, 1043, 1044, 1045, 1046, 1047, 1048, 1049, 1050, 1051, 1052, 1053, 1054, 1055, 1056, 1057, 1058, 1059, 1060, 1061, 1062, 1063, 1064, 1065, 1066, 1067, 1068, 1069, 1070, 1071, 1072, 1073, 1074, 1075, 1076, 1077, 1078, 1079, 1080, 1081, 1082, 1083, 1084, 1085, 1086, 1087, 1088, 1089, 1090, 1091, 1092, 1093, 1094, 1095, 1096, 1097, 1098, 1099, 1100, 1101, 1102, 1103, 1104, 1105, 1106, 1107, 1108, 1109, 1110, 1111, 1112, 1113, 1114, 1115, 1116, 1117, 1118, 1119, 1120, 1121, 1122, 1123, 1124, 1125, 1126, 1127, 1128, 1129, 1130, 1131, 1132, 1133, 1134, 1135, 1136, 1137, 1138, 1139, 1140, 1141, 1142, 1143, 1144, 1145, 1146, 1147, 1148, 1149, 1150, 1151, 1152, 1153, 1154, 1155, 1156, 1157, 1158, 1159, 1160, 1161, 1162, 1163, 1164, 1165, 1166, 1167, 1168, 1169, 1170, 1171, 1172, 1173, 1174, 1175, 1176, 1177, 1178, 1179, 1180, 1181, 1182, 1183, 1184, 1185, 1186, 1187, 1188, 1189, 1190, 1191, 1192, 1193, 1194, 1195, 1196, 1197, 1198, 1199, 1200, 1201, 1202, 1203, 1204, 1205, 1206, 1207, 1208, 1209, 1210, 1211, 1212, 1213, 1214, 1215, 1216, 1217, 1218, 1219, 1220, 1221, 1222, 1223, 1224, 1225, 1226, 1227, 1228, 1229, 1230, 1231, 1232, 1233, 1234, 1235, 1236, 1237, 1238, 1239, 1240, 1241, 1242, 1243, 1244, 1245, 1246, 1247, 1248, 1249, 1250, 1251, 1252, 1253, 1254, 1255, 1256, 1257, 1258, 1259, 1260, 1261, 1262, 1263, 1264, 1265, 1266, 1267, 1268, 1269, 1270, 1271, 1272, 1273, 1274, 1275, 1276, 1277, 1278, 1279, 1280, 1281, 1282, 1283, 1284, 1285, 1286, 1287, 1288, 1289, 1290, 1291, 1292, 1293, 1294, 1295, 1296, 1297, 1298, 1299, 1300, 1301, 1302, 1303, 1304, 1305, 1306, 1307, 1308, 1309, 1310, 1311, 1312, 1313, 1314, 1315, 1316, 1317, 1318, 1319, 1320, 1321, 1322, 1323, 1324, 1325, 1326, 1327, 1328, 1329, 1330, 1331, 1332, 1333, 1334, 1335, 1336, 1337, 1338, 1339, 1340, 1341, 1342, 1343, 1344, 1345, 1346, 1347, 1348, 1349, 1350, 1351, 1352, 1353, 1354, 1355, 1356, 1357, 1358, 1359, 1360, 1361, 1362, 1363, 1364, 1365, 1366, 1367, 1368, 1369, 1370, 1371, 1372, 1373, 1374, 1375, 1376, 1377, 1378, 1379, 1380, 1381, 1382, 1383, 1384, 1385, 1386, 1387, 1388, 1389, 1390, 1391, 1392, 1393, 1394, 1395, 1396, 1397, 1398, 1399, 1400, 1401, 1402, 1403, 1404, 1405, 1406, 1407, 1408, 1409, 1410, 1411, 1412, 1413, 1414, 1415, 1416, 1417, 1418, 1419, 1420, 1421, 1422, 1423, 1424, 1425, 1426, 1427, 1428, 1429, 1430, 1431, 1432, 1433, 1434, 1435, 1436, 1437, 1438, 1439, 1440, 1441, 1442, 1443, 1444, 1445, 1446, 1447, 1448, 1449, 1450, 1451, 1452, 1453, 1454, 1455, 1456, 1457, 1458, 1459, 1460, 1461, 1462, 1463, 1464, 1465, 1466, 1467, 1468, 1469, 1470, 1471, 1472, 1473, 1474, 1475, 1476, 1477, 1478, 1479, 1480, 1481, 1482, 1483, 1484, 1485, 1486, 1487, 1488, 1489, 1490, 1491, 1492, 1493, 1494, 1495, 1496, 1497, 1498, 1499, 1500, 1501, 1502, 1503, 1504, 1505, 1506, 1507, 1508, 1509, 1510, 1511, 1512, 1513, 1514, 1515, 1516, 1517, 1518, 1519, 1520, 1521, 1522, 1523, 1524, 1525, 1526, 1527, 1528, 1529, 1530, 1531, 1532, 1533, 1534, 1535, 1536, 1537, 1538, 1539, 1540, 1541, 1542, 1543, 1544, 1545, 1546, 1547, 1548, 1549, 1550, 1551, 1552, 1553, 1554, 1555, 1556, 1557, 1558, 1559, 1560, 1561, 1562, 1563, 1564, 1565, 1566, 1567, 1568, 1569, 1570, 1571, 1572, 1573, 1574, 1575, 1576, 1577, 1578, 1579, 1580, 1581, 1582, 1583, 1584, 1585, 1586, 1587, 1588, 1589, 1590, 1591, 1592, 1593, 1594, 1595, 1596, 1597, 1598, 1599, 1600, 1601, 1602, 1603, 1604, 1605, 1606, 1607, 1608, 1609, 1610, 1611, 1612, 1613, 1614, 1615, 1616, 1617, 1618, 1619, 1620, 1621, 1622, 1623, 1624, 1625, 1626, 1627, 1628, 1629, 1630, 1631, 1632, 1633, 1634, 1635, 1636, 1637, 1638, 1639, 1640, 1641, 1642, 1643, 1644, 1645, 1646, 1647, 1648, 1649, 1650, 1651, 1652, 1653, 1654, 1655, 1656, 1657, 1658, 1659, 1660, 1661, 1662, 1663, 1664, 1665, 1666, 1667, 1668, 1669, 1670, 1671, 1672, 1673, 1674, 1675, 1676, 1677, 1678, 1679, 1680, 1681, 1682, 1683, 1684, 1685, 1686, 1687, 1688, 1689, 1690, 1691, 1692, 1693, 1694, 1695, 1696, 1697, 1698, 1699, 1700, 1701, 1702, 1703, 1704, 1705, 1706, 1707, 1708, 1709, 1710, 1711, 1712, 1713, 1714, 1715, 1716, 1717, 1718, 1719, 1720, 1721, 1722, 1723, 1724, 1725, 1726, 1727, 1728, 1729, 1730, 1731, 1732, 1733, 1734, 1735, 1736, 1737, 1738, 1739, 1740, 1741, 1742, 1743, 1744, 1745, 1746, 1747, 1748, 1749, 1750, 1751, 1752, 1753, 1754, 1755, 1756, 1757, 1758, 1759, 1760, 1761, 1762, 1763, 1764, 1765, 1766, 1767, 1768, 1769, 1770, 1771, 1772, 1773, 1774, 1775, 1776, 1777, 1778, 1779, 1780, 1781, 1782, 1783, 1784, 1785, 1786, 1787, 1788, 1789, 1790, 1791, 1792, 1793, 1794, 1795, 1796, 1797, 1798, 1799, 1800, 1801, 1802, 1803, 1804, 1805, 1806, 1807, 1808, 1809, 1810, 1811, 1812, 1813, 1814, 1815, 1816, 1817, 1818, 1819, 1820, 1821, 1822, 1823, 1824, 1825, 1826, 1827, 1828, 1829, 1830, 1831, 1832, 1833, 1834, 1835, 1836, 1837, 1838, 1839, 1840, 1841, 1842, 1843, 1844, 1845, 1846, 1847, 1848, 1849, 1850, 1851, 1852, 1853, 1854, 1855, 1856, 1857, 1858, 1859, 1860, 1861, 1862, 1863, 1864, 1865, 1866, 1867, 1868, 1869, 1870, 1871, 1872, 1873, 1874, 1875, 1876, 1877, 1878, 1879, 1880, 1881, 1882, 1883, 1884, 1885, 1886, 1887, 1888, 1889, 1890, 1891, 1892, 1893, 1894, 1895, 1896, 1897, 1898, 1899, 1900, 1901, 1902, 1903, 1904, 1905, 1906, 1907, 1908, 1909, 1910, 1911, 1912, 1913, 1914, 1915, 1916, 1917, 1918, 1919, 1920, 1921, 1922, 1923, 1924, 1925, 1926, 1927, 1928, 1929, 1930, 1931, 1932, 1933, 1934, 1935, 1936, 1937, 1938, 1939, 1940, 1941, 1942, 1943, 1944, 1945, 1946, 1947, 1948, 1949, 1950, 1951, 1952, 1953, 1954, 1955, 1956, 1957, 1958, 1959, 1960, 1961, 1962, 1963, 1964, 1965, 1966, 1967, 1968, 1969, 1970, 1971, 1972, 1973, 1974, 1975, 1976, 1977, 1978, 1979, 1980, 1981, 1982, 1983, 1984, 1985, 1986, 1987, 1988, 1989, 1990, 1991, 1992, 1993, 1994, 1995, 1996, 1997, 1998, 1999, 2000, 2001, 2002, 2003, 2004, 2005, 2006, 2007, 2008, 2009, 2010, 2011, 2012, 2013, 2014, 2015, 2016, 2017, 2018, 2019, 2020, 2021, 2022, 2023, 2024, 2025, 2026, 2027, 2028, 2029, 2030, 2031, 2032, 2033, 2034, 2035, 2036, 2037, 2038, 2039, 2040, 2041, 2042, 2043, 2044, 2045, 2046, 2047, 2048, 2049, 2050, 2051, 2052, 2053, 2054, 2055, 2056, 2057, 2058, 2059, 2060, 2061, 2062, 2063, 2064, 2065, 2066, 2067, 2068, 2069, 2070, 2071, 2072, 2073, 2074, 2075, 2076, 2077, 2078, 2079, 2080, 2081, 2082, 2083, 2084, 2085, 2086, 2087, 2088, 2089, 2090, 2091, 2092, 2093, 2094, 2095, 2096, 2097, 2098, 2099, 2100, 2101, 2102, 2103, 2104, 2105, 2106, 2107, 2108, 2109, 2110, 2111, 2112, 2113, 2114, 2115, 2116, 2117, 2118, 2119, 2120, 2121, 2122, 2123, 2124, 2125, 2126, 2127, 2128, 2129, 2130, 2131, 2132, 2133, 2134, 2135, 2136, 2137, 2138, 2139, 2140, 2141, 2142, 2143, 2144, 2145, 2146, 2147, 2148, 2149, 2150, 2151, 2152, 2153, 2154, 2155, 2156, 2157, 2158, 2159, 2160, 2161, 2162, 2163, 2164, 2165, 2166, 2167, 2168, 2169, 2170, 2171, 2172, 2173, 2174, 2175, 2176, 2177, 2178, 2179, 2180, 2181, 2182, 2183, 2184, 2185, 2186, 2187, 2188, 2189, 2190, 2191, 2192, 2193, 2194, 2195, 2196, 2197, 2198, 2199, 2200, 2201, 2202, 2203, 2204, 2205, 2206, 2207, 2208, 2209, 2210, 2211, 2212, 2213, 2214, 2215, 2216, 2217, 2218, 2219, 2220, 2221, 2222, 2223, 2224, 2225, 2226, 2227, 2228, 2229, 2230, 2231, 2232, 2233, 2234, 2235, 2236, 2237, 2238, 2239, 2240, 2241, 2242, 2243, 2244, 2245, 2246, 2247, 2248, 2249, 2250, 2251, 2252, 2253, 2254, 2255, 2256, 2257, 2258, 2259, 2260, 2261, 2262, 2263, 2264, 2265, 2266, 2267, 2268, 2269, 2270, 2271, 2272, 2273, 2274, 2275, 2276, 2277, 2278, 2279, 2280, 2281, 2282, 2283, 2284, 2285, 2286, 2287, 2288, 2289, 2290, 2291, 2292, 2293, 2294, 2295, 2296, 2297, 2298, 2299, 2300, 2301, 2302, 2303, 2304, 2305, 2306, 2307, 2308, 2309, 2310, 2311, 2312, 2313, 2314, 2315, 2316, 2317, 2318, 2319, 2320, 2321, 2322, 2323, 2324, 2325, 2326, 2327, 2328, 2329, 2330, 2331, 2332, 2333, 2334, 2335, 2336, 2337, 2338, 2339, 2340, 2341, 2342, 2343, 2344, 2345, 2346, 2347, 2348, 2349, 2350, 2351, 2352, 2353, 2354, 2355, 2356, 2357, 2358, 2359, 2360, 2361, 2362, 2363, 2364, 2365, 2366, 2367, 2368, 2369, 2370, 2371, 2372, 2373, 2374, 2375, 2376, 2377, 2378, 2379, 2380, 2381, 2382, 2383, 2384, 2385, 2386, 2387, 2388, 2389, 2390, 2391, 2392, 2393, 2394, 2395, 2396, 2397, 2398, 2399, 2400, 2401, 2402, 2403, 2404, 2405, 2406, 2407, 2408, 2409, 2410, 2411, 2412, 2413, 2414, 2415, 2416, 2417, 2418, 2419, 2420, 2421, 2422, 2423, 2424, 2425, 2426, 2427, 2428, 2429, 2430, 2431, 2432, 2433, 2434, 2435, 2436, 2437, 2438, 2439, 2440, 2441, 2442, 2443, 2444, 2445, 2446, 2447, 2448, 2449, 2450, 2451, 2452, 2453, 2454, 2455, 2456, 2457, 2458, 2459, 2460, 2461, 2462, 2463, 2464, 2465, 2466, 2467, 2468, 2469, 2470, 2471, 2472, 2473, 2474, 2475, 2476, 2477, 2478, 2479, 2480, 2481, 2482, 2483, 2484, 2485, 2486, 2487, 2488, 2489, 2490, 2491, 2492, 2493, 2494, 2495, 2496, 2497, 2498, 2499, 2500, square feet, and/or any combination thereof.

In some aspects, the techniques described herein may relate to system filter units that may be arranged in parallel and/or sequential for best airflow and/or filtration. For example, a sequential or parallel filter setup may be pre-filter to HEPA to carbon for maximum efficiency.

In some aspects, the techniques described herein may relate to system filter units that may filter large-scale purification, for example 1000 to 4000 CFM (Cubic Feet per Minute). For example, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 291, 292, 293, 294, 295, 296, 297, 298, 299, 300, 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 348, 349, 350, 351, 352, 353, 354, 355, 356, 357, 358, 359, 360, 361, 362, 363, 364, 365, 366, 367, 368, 369, 370, 371, 372, 373, 374, 375, 376, 377, 378, 379, 380, 381, 382, 383, 384, 385, 386, 387, 388, 389, 390, 391, 392, 393, 394, 395, 396, 397, 398, 399, 400, 401, 402, 403, 404, 405, 406, 407, 408, 409, 410, 411, 412, 413, 414, 415, 416, 417, 418, 419, 420, 421, 422, 423, 424, 425, 426, 427, 428, 429, 430, 431, 432, 433, 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 501, 502, 503, 504, 505, 506, 507, 508, 509, 510, 511, 512, 513, 514, 515, 516, 517, 518, 519, 520, 521, 522, 523, 524, 525, 526, 527, 528, 529, 530, 531, 532, 533, 534, 535, 536, 537, 538, 539, 540, 541, 542, 543, 544, 545, 546, 547, 548, 549, 550, 551, 552, 553, 554, 555, 556, 557, 558, 559, 560, 561, 562, 563, 564, 565, 566, 567, 568, 569, 570, 571, 572, 573, 574, 575, 576, 577, 578, 579, 580, 581, 582, 583, 584, 585, 586, 587, 588, 589, 590, 591, 592, 593, 594, 595, 596, 597, 598, 599, 600, 601, 602, 603, 604, 605, 606, 607, 608, 609, 610, 611, 612, 613, 614, 615, 616, 617, 618, 619, 620, 621, 622, 623, 624, 625, 626, 627, 628, 629, 630, 631, 632, 633, 634, 635, 636, 637, 638, 639, 640, 641, 642, 643, 644, 645, 646, 647, 648, 649, 650, 651, 652, 653, 654, 655, 656, 657, 658, 659, 660, 661, 662, 663, 664, 665, 666, 667, 668, 669, 670, 671, 672, 673, 674, 675, 676, 677, 678, 679, 680, 681, 682, 683, 684, 685, 686, 687, 688, 689, 690, 691, 692, 693, 694, 695, 696, 697, 698, 699, 700, 701, 702, 703, 704, 705, 706, 707, 708, 709, 710, 711, 712, 713, 714, 715, 716, 717, 718, 719, 720, 721, 722, 723, 724, 725, 726, 727, 728, 729, 730, 731, 732, 733, 734, 735, 736, 737, 738, 739, 740, 741, 742, 743, 744, 745, 746, 747, 748, 749, 750, 751, 752, 753, 754, 755, 756, 757, 758, 759, 760, 761, 762, 763, 764, 765, 766, 767, 768, 769, 770, 771, 772, 773, 774, 775, 776, 777, 778, 779, 780, 781, 782, 783, 784, 785, 786, 787, 788, 789, 790, 791, 792, 793, 794, 795, 796, 797, 798, 799, 800, 801, 802, 803, 804, 805, 806, 807, 808, 809, 810, 811, 812, 813, 814, 815, 816, 817, 818, 819, 820, 821, 822, 823, 824, 825, 826, 827, 828, 829, 830, 831, 832, 833, 834, 835, 836, 837, 838, 839, 840, 841, 842, 843, 844, 845, 846, 847, 848, 849, 850, 851, 852, 853, 854, 855, 856, 857, 858, 859, 860, 861, 862, 863, 864, 865, 866, 867, 868, 869, 870, 871, 872, 873, 874, 875, 876, 877, 878, 879, 880, 881, 882, 883, 884, 885, 886, 887, 888, 889, 890, 891, 892, 893, 894, 895, 896, 897, 898, 899, 900, 901, 902, 903, 904, 905, 906, 907, 908, 909, 910, 911, 912, 913, 914, 915, 916, 917, 918, 919, 920, 921, 922, 923, 924, 925, 926, 927, 928, 929, 930, 931, 932, 933, 934, 935, 936, 937, 938, 939, 940, 941, 942, 943, 944, 945, 946, 947, 948, 949, 950, 951, 952, 953, 954, 955, 956, 957, 958, 959, 960, 961, 962, 963, 964, 965, 966, 967, 968, 969, 970, 971, 972, 973, 974, 975, 976, 977, 978, 979, 980, 981, 982, 983, 984, 985, 986, 987, 988, 989, 990, 991, 992, 993, 994, 995, 996, 997, 998, 999, 1000, 1000, 1001, 1002, 1003, 1004, 1005, 1006, 1007, 1008, 1009, 1010, 1011, 1012, 1013, 1014, 1015, 1016, 1017, 1018, 1019, 1020, 1021, 1022, 1023, 1024, 1025, 1026, 1027, 1028, 1029, 1030, 1031, 1032, 1033, 1034, 1035, 1036, 1037, 1038, 1039, 1040, 1041, 1042, 1043, 1044, 1045, 1046, 1047, 1048, 1049, 1050, 1051, 1052, 1053, 1054, 1055, 1056, 1057, 1058, 1059, 1060, 1061, 1062, 1063, 1064, 1065, 1066, 1067, 1068, 1069, 1070, 1071, 1072, 1073, 1074, 1075, 1076, 1077, 1078, 1079, 1080, 1081, 1082, 1083, 1084, 1085, 1086, 1087, 1088, 1089, 1090, 1091, 1092, 1093, 1094, 1095, 1096, 1097, 1098, 1099, 1100, 1101, 1102, 1103, 1104, 1105, 1106, 1107, 1108, 1109, 1110, 1111, 1112, 1113, 1114, 1115, 1116, 1117, 1118, 1119, 1120, 1121, 1122, 1123, 1124, 1125, 1126, 1127, 1128, 1129, 1130, 1131, 1132, 1133, 1134, 1135, 1136, 1137, 1138, 1139, 1140, 1141, 1142, 1143, 1144, 1145, 1146, 1147, 1148, 1149, 1150, 1151, 1152, 1153, 1154, 1155, 1156, 1157, 1158, 1159, 1160, 1161, 1162, 1163, 1164, 1165, 1166, 1167, 1168, 1169, 1170, 1171, 1172, 1173, 1174, 1175, 1176, 1177, 1178, 1179, 1180, 1181, 1182, 1183, 1184, 1185, 1186, 1187, 1188, 1189, 1190, 1191, 1192, 1193, 1194, 1195, 1196, 1197, 1198, 1199, 1200, 1201, 1202, 1203, 1204, 1205, 1206, 1207, 1208, 1209, 1210, 1211, 1212, 1213, 1214, 1215, 1216, 1217, 1218, 1219, 1220, 1221, 1222, 1223, 1224, 1225, 1226, 1227, 1228, 1229, 1230, 1231, 1232, 1233, 1234, 1235, 1236, 1237, 1238, 1239, 1240, 1241, 1242, 1243, 1244, 1245, 1246, 1247, 1248, 1249, 1250, 1251, 1252, 1253, 1254, 1255, 1256, 1257, 1258, 1259, 1260, 1261, 1262, 1263, 1264, 1265, 1266, 1267, 1268, 1269, 1270, 1271, 1272, 1273, 1274, 1275, 1276, 1277, 1278, 1279, 1280, 1281, 1282, 1283, 1284, 1285, 1286, 1287, 1288, 1289, 1290, 1291, 1292, 1293, 1294, 1295, 1296, 1297, 1298, 1299, 1300, 1301, 1302, 1303, 1304, 1305, 1306, 1307, 1308, 1309, 1310, 1311, 1312, 1313, 1314, 1315, 1316, 1317, 1318, 1319, 1320, 1321, 1322, 1323, 1324, 1325, 1326, 1327, 1328, 1329, 1330, 1331, 1332, 1333, 1334, 1335, 1336, 1337, 1338, 1339, 1340, 1341, 1342, 1343, 1344, 1345, 1346, 1347, 1348, 1349, 1350, 1351, 1352, 1353, 1354, 1355, 1356, 1357, 1358, 1359, 1360, 1361, 1362, 1363, 1364, 1365, 1366, 1367, 1368, 1369, 1370, 1371, 1372, 1373, 1374, 1375, 1376, 1377, 1378, 1379, 1380, 1381, 1382, 1383, 1384, 1385, 1386, 1387, 1388, 1389, 1390, 1391, 1392, 1393, 1394, 1395, 1396, 1397, 1398, 1399, 1400, 1401, 1402, 1403, 1404, 1405, 1406, 1407, 1408, 1409, 1410, 1411, 1412, 1413, 1414, 1415, 1416, 1417, 1418, 1419, 1420, 1421, 1422, 1423, 1424, 1425, 1426, 1427, 1428, 1429, 1430, 1431, 1432, 1433, 1434, 1435, 1436, 1437, 1438, 1439, 1440, 1441, 1442, 1443, 1444, 1445, 1446, 1447, 1448, 1449, 1450, 1451, 1452, 1453, 1454, 1455, 1456, 1457, 1458, 1459, 1460, 1461, 1462, 1463, 1464, 1465, 1466, 1467, 1468, 1469, 1470, 1471, 1472, 1473, 1474, 1475, 1476, 1477, 1478, 1479, 1480, 1481, 1482, 1483, 1484, 1485, 1486, 1487, 1488, 1489, 1490, 1491, 1492, 1493, 1494, 1495, 1496, 1497, 1498, 1499, 1500, 1501, 1502, 1503, 1504, 1505, 1506, 1507, 1508, 1509, 1510, 1511, 1512, 1513, 1514, 1515, 1516, 1517, 1518, 1519, 1520, 1521, 1522, 1523, 1524, 1525, 1526, 1527, 1528, 1529, 1530, 1531, 1532, 1533, 1534, 1535, 1536, 1537, 1538, 1539, 1540, 1541, 1542, 1543, 1544, 1545, 1546, 1547, 1548, 1549, 1550, 1551, 1552, 1553, 1554, 1555, 1556, 1557, 1558, 1559, 1560, 1561, 1562, 1563, 1564, 1565, 1566, 1567, 1568, 1569, 1570, 1571, 1572, 1573, 1574, 1575, 1576, 1577, 1578, 1579, 1580, 1581, 1582, 1583, 1584, 1585, 1586, 1587, 1588, 1589, 1590, 1591, 1592, 1593, 1594, 1595, 1596, 1597, 1598, 1599, 1600, 1601, 1602, 1603, 1604, 1605, 1606, 1607, 1608, 1609, 1610, 1611, 1612, 1613, 1614, 1615, 1616, 1617, 1618, 1619, 1620, 1621, 1622, 1623, 1624, 1625, 1626, 1627, 1628, 1629, 1630, 1631, 1632, 1633, 1634, 1635, 1636, 1637, 1638, 1639, 1640, 1641, 1642, 1643, 1644, 1645, 1646, 1647, 1648, 1649, 1650, 1651, 1652, 1653, 1654, 1655, 1656, 1657, 1658, 1659, 1660, 1661, 1662, 1663, 1664, 1665, 1666, 1667, 1668, 1669, 1670, 1671, 1672, 1673, 1674, 1675, 1676, 1677, 1678, 1679, 1680, 1681, 1682, 1683, 1684, 1685, 1686, 1687, 1688, 1689, 1690, 1691, 1692, 1693, 1694, 1695, 1696, 1697, 1698, 1699, 1700, 1701, 1702, 1703, 1704, 1705, 1706, 1707, 1708, 1709, 1710, 1711, 1712, 1713, 1714, 1715, 1716, 1717, 1718, 1719, 1720, 1721, 1722, 1723, 1724, 1725, 1726, 1727, 1728, 1729, 1730, 1731, 1732, 1733, 1734, 1735, 1736, 1737, 1738, 1739, 1740, 1741, 1742, 1743, 1744, 1745, 1746, 1747, 1748, 1749, 1750, 1751, 1752, 1753, 1754, 1755, 1756, 1757, 1758, 1759, 1760, 1761, 1762, 1763, 1764, 1765, 1766, 1767, 1768, 1769, 1770, 1771, 1772, 1773, 1774, 1775, 1776, 1777, 1778, 1779, 1780, 1781, 1782, 1783, 1784, 1785, 1786, 1787, 1788, 1789, 1790, 1791, 1792, 1793, 1794, 1795, 1796, 1797, 1798, 1799, 1800, 1801, 1802, 1803, 1804, 1805, 1806, 1807, 1808, 1809, 1810, 1811, 1812, 1813, 1814, 1815, 1816, 1817, 1818, 1819, 1820, 1821, 1822, 1823, 1824, 1825, 1826, 1827, 1828, 1829, 1830, 1831, 1832, 1833, 1834, 1835, 1836, 1837, 1838, 1839, 1840, 1841, 1842, 1843, 1844, 1845, 1846, 1847, 1848, 1849, 1850, 1851, 1852, 1853, 1854, 1855, 1856, 1857, 1858, 1859, 1860, 1861, 1862, 1863, 1864, 1865, 1866, 1867, 1868, 1869, 1870, 1871, 1872, 1873, 1874, 1875, 1876, 1877, 1878, 1879, 1880, 1881, 1882, 1883, 1884, 1885, 1886, 1887, 1888, 1889, 1890, 1891, 1892, 1893, 1894, 1895, 1896, 1897, 1898, 1899, 1900, 1901, 1902, 1903, 1904, 1905, 1906, 1907, 1908, 1909, 1910, 1911, 1912, 1913, 1914, 1915, 1916, 1917, 1918, 1919, 1920, 1921, 1922, 1923, 1924, 1925, 1926, 1927, 1928, 1929, 1930, 1931, 1932, 1933, 1934, 1935, 1936, 1937, 1938, 1939, 1940, 1941, 1942, 1943, 1944, 1945, 1946, 1947, 1948, 1949, 1950, 1951, 1952, 1953, 1954, 1955, 1956, 1957, 1958, 1959, 1960, 1961, 1962, 1963, 1964, 1965, 1966, 1967, 1968, 1969, 1970, 1971, 1972, 1973, 1974, 1975, 1976, 1977, 1978, 1979, 1980, 1981, 1982, 1983, 1984, 1985, 1986, 1987, 1988, 1989, 1990, 1991, 1992, 1993, 1994, 1995, 1996, 1997, 1998, 1999, 2000, 2000, 2001, 2002, 2003, 2004, 2005, 2006, 2007, 2008, 2009, 2010, 2011, 2012, 2013, 2014, 2015, 2016, 2017, 2018, 2019, 2020, 2021, 2022, 2023, 2024, 2025, 2026, 2027, 2028, 2029, 2030, 2031, 2032, 2033, 2034, 2035, 2036, 2037, 2038, 2039, 2040, 2041, 2042, 2043, 2044, 2045, 2046, 2047, 2048, 2049, 2050, 2051, 2052, 2053, 2054, 2055, 2056, 2057, 2058, 2059, 2060, 2061, 2062, 2063, 2064, 2065, 2066, 2067, 2068, 2069, 2070, 2071, 2072, 2073, 2074, 2075, 2076, 2077, 2078, 2079, 2080, 2081, 2082, 2083, 2084, 2085, 2086, 2087, 2088, 2089, 2090, 2091, 2092, 2093, 2094, 2095, 2096, 2097, 2098, 2099, 2100, 2101, 2102, 2103, 2104, 2105, 2106, 2107, 2108, 2109, 2110, 2111, 2112, 2113, 2114, 2115, 2116, 2117, 2118, 2119, 2120, 2121, 2122, 2123, 2124, 2125, 2126, 2127, 2128, 2129, 2130, 2131, 2132, 2133, 2134, 2135, 2136, 2137, 2138, 2139, 2140, 2141, 2142, 2143, 2144, 2145, 2146, 2147, 2148, 2149, 2150, 2151, 2152, 2153, 2154, 2155, 2156, 2157, 2158, 2159, 2160, 2161, 2162, 2163, 2164, 2165, 2166, 2167, 2168, 2169, 2170, 2171, 2172, 2173, 2174, 2175, 2176, 2177, 2178, 2179, 2180, 2181, 2182, 2183, 2184, 2185, 2186, 2187, 2188, 2189, 2190, 2191, 2192, 2193, 2194, 2195, 2196, 2197, 2198, 2199, 2200, 2201, 2202, 2203, 2204, 2205, 2206, 2207, 2208, 2209, 2210, 2211, 2212, 2213, 2214, 2215, 2216, 2217, 2218, 2219, 2220, 2221, 2222, 2223, 2224, 2225, 2226, 2227, 2228, 2229, 2230, 2231, 2232, 2233, 2234, 2235, 2236, 2237, 2238, 2239, 2240, 2241, 2242, 2243, 2244, 2245, 2246, 2247, 2248, 2249, 2250, 2251, 2252, 2253, 2254, 2255, 2256, 2257, 2258, 2259, 2260, 2261, 2262, 2263, 2264, 2265, 2266, 2267, 2268, 2269, 2270, 2271, 2272, 2273, 2274, 2275, 2276, 2277, 2278, 2279, 2280, 2281, 2282, 2283, 2284, 2285, 2286, 2287, 2288, 2289, 2290, 2291, 2292, 2293, 2294, 2295, 2296, 2297, 2298, 2299, 2300, 2301, 2302, 2303, 2304, 2305, 2306, 2307, 2308, 2309, 2310, 2311, 2312, 2313, 2314, 2315, 2316, 2317, 2318, 2319, 2320, 2321, 2322, 2323, 2324, 2325, 2326, 2327, 2328, 2329, 2330, 2331, 2332, 2333, 2334, 2335, 2336, 2337, 2338, 2339, 2340, 2341, 2342, 2343, 2344, 2345, 2346, 2347, 2348, 2349, 2350, 2351, 2352, 2353, 2354, 2355, 2356, 2357, 2358, 2359, 2360, 2361, 2362, 2363, 2364, 2365, 2366, 2367, 2368, 2369, 2370, 2371, 2372, 2373, 2374, 2375, 2376, 2377, 2378, 2379, 2380, 2381, 2382, 2383, 2384, 2385, 2386, 2387, 2388, 2389, 2390, 2391, 2392, 2393, 2394, 2395, 2396, 2397, 2398, 2399, 2400, 2401, 2402, 2403, 2404, 2405, 2406, 2407, 2408, 2409, 2410, 2411, 2412, 2413, 2414, 2415, 2416, 2417, 2418, 2419, 2420, 2421, 2422, 2423, 2424, 2425, 2426, 2427, 2428, 2429, 2430, 2431, 2432, 2433, 2434, 2435, 2436, 2437, 2438, 2439, 2440, 2441, 2442, 2443, 2444, 2445, 2446, 2447, 2448, 2449, 2450, 2451, 2452, 2453, 2454, 2455, 2456, 2457, 2458, 2459, 2460, 2461, 2462, 2463, 2464, 2465, 2466, 2467, 2468, 2469, 2470, 2471, 2472, 2473, 2474, 2475, 2476, 2477, 2478, 2479, 2480, 2481, 2482, 2483, 2484, 2485, 2486, 2487, 2488, 2489, 2490, 2491, 2492, 2493, 2494, 2495, 2496, 2497, 2498, 2499, 2500, 2501, 2502, 2503, 2504, 2505, 2506, 2507, 2508, 2509, 2510, 2511, 2512, 2513, 2514, 2515, 2516, 2517, 2518, 2519, 2520, 2521, 2522, 2523, 2524, 2525, 2526, 2527, 2528, 2529, 2530, 2531, 2532, 2533, 2534, 2535, 2536, 2537, 2538, 2539, 2540, 2541, 2542, 2543, 2544, 2545, 2546, 2547, 2548, 2549, 2550, 2551, 2552, 2553, 2554, 2555, 2556, 2557, 2558, 2559, 2560, 2561, 2562, 2563, 2564, 2565, 2566, 2567, 2568, 2569, 2570, 2571, 2572, 2573, 2574, 2575, 2576, 2577, 2578, 2579, 2580, 2581, 2582, 2583, 2584, 2585, 2586, 2587, 2588, 2589, 2590, 2591, 2592, 2593, 2594, 2595, 2596, 2597, 2598, 2599, 2600, 2601, 2602, 2603, 2604, 2605, 2606, 2607, 2608, 2609, 2610, 2611, 2612, 2613, 2614, 2615, 2616, 2617, 2618, 2619, 2620, 2621, 2622, 2623, 2624, 2625, 2626, 2627, 2628, 2629, 2630, 2631, 2632, 2633, 2634, 2635, 2636, 2637, 2638, 2639, 2640, 2641, 2642, 2643, 2644, 2645, 2646, 2647, 2648, 2649, 2650, 2651, 2652, 2653, 2654, 2655, 2656, 2657, 2658, 2659, 2660, 2661, 2662, 2663, 2664, 2665, 2666, 2667, 2668, 2669, 2670, 2671, 2672, 2673, 2674, 2675, 2676, 2677, 2678, 2679, 2680, 2681, 2682, 2683, 2684, 2685, 2686, 2687, 2688, 2689, 2690, 2691, 2692, 2693, 2694, 2695, 2696, 2697, 2698, 2699, 2700, 2701, 2702, 2703, 2704, 2705, 2706, 2707, 2708, 2709, 2710, 2711, 2712, 2713, 2714, 2715, 2716, 2717, 2718, 2719, 2720, 2721, 2722, 2723, 2724, 2725, 2726, 2727, 2728, 2729, 2730, 2731, 2732, 2733, 2734, 2735, 2736, 2737, 2738, 2739, 2740, 2741, 2742, 2743, 2744, 2745, 2746, 2747, 2748, 2749, 2750, 2751, 2752, 2753, 2754, 2755, 2756, 2757, 2758, 2759, 2760, 2761, 2762, 2763, 2764, 2765, 2766, 2767, 2768, 2769, 2770, 2771, 2772, 2773, 2774, 2775, 2776, 2777, 2778, 2779, 2780, 2781, 2782, 2783, 2784, 2785, 2786, 2787, 2788, 2789, 2790, 2791, 2792, 2793, 2794, 2795, 2796, 2797, 2798, 2799, 2800, 2801, 2802, 2803, 2804, 2805, 2806, 2807, 2808, 2809, 2810, 2811, 2812, 2813, 2814, 2815, 2816, 2817, 2818, 2819, 2820, 2821, 2822, 2823, 2824, 2825, 2826, 2827, 2828, 2829, 2830, 2831, 2832, 2833, 2834, 2835, 2836, 2837, 2838, 2839, 2840, 2841, 2842, 2843, 2844, 2845, 2846, 2847, 2848, 2849, 2850, 2851, 2852, 2853, 2854, 2855, 2856, 2857, 2858, 2859, 2860, 2861, 2862, 2863, 2864, 2865, 2866, 2867, 2868, 2869, 2870, 2871, 2872, 2873, 2874, 2875, 2876, 2877, 2878, 2879, 2880, 2881, 2882, 2883, 2884, 2885, 2886, 2887, 2888, 2889, 2890, 2891, 2892, 2893, 2894, 2895, 2896, 2897, 2898, 2899, 2900, 2901, 2902, 2903, 2904, 2905, 2906, 2907, 2908, 2909, 2910, 2911, 2912, 2913, 2914, 2915, 2916, 2917, 2918, 2919, 2920, 2921, 2922, 2923, 2924, 2925, 2926, 2927, 2928, 2929, 2930, 2931, 2932, 2933, 2934, 2935, 2936, 2937, 2938, 2939, 2940, 2941, 2942, 2943, 2944, 2945, 2946, 2947, 2948, 2949, 2950, 2951, 2952, 2953, 2954, 2955, 2956, 2957, 2958, 2959, 2960, 2961, 2962, 2963, 2964, 2965, 2966, 2967, 2968, 2969, 2970, 2971, 2972, 2973, 2974, 2975, 2976, 2977, 2978, 2979, 2980, 2981, 2982, 2983, 2984, 2985, 2986, 2987, 2988, 2989, 2990, 2991, 2992, 2993, 2994, 2995, 2996, 2997, 2998, 2999, 3000, 3001, 3002, 3003, 3004, 3005, 3006, 3007, 3008, 3009, 3010, 3011, 3012, 3013, 3014, 3015, 3016, 3017, 3018, 3019, 3020, 3021, 3022, 3023, 3024, 3025, 3026, 3027, 3028, 3029, 3030, 3031, 3032, 3033, 3034, 3035, 3036, 3037, 3038, 3039, 3040, 3041, 3042, 3043, 3044, 3045, 3046, 3047, 3048, 3049, 3050, 3051, 3052, 3053, 3054, 3055, 3056, 3057, 3058, 3059, 3060, 3061, 3062, 3063, 3064, 3065, 3066, 3067, 3068, 3069, 3070, 3071, 3072, 3073, 3074, 3075, 3076, 3077, 3078, 3079, 3080, 3081, 3082, 3083, 3084, 3085, 3086, 3087, 3088, 3089, 3090, 3091, 3092, 3093, 3094, 3095, 3096, 3097, 3098, 3099, 3100, 3101, 3102, 3103, 3104, 3105, 3106, 3107, 3108, 3109, 3110, 3111, 3112, 3113, 3114, 3115, 3116, 3117, 3118, 3119, 3120, 3121, 3122, 3123, 3124, 3125, 3126, 3127, 3128, 3129, 3130, 3131, 3132, 3133, 3134, 3135, 3136, 3137, 3138, 3139, 3140, 3141, 3142, 3143, 3144, 3145, 3146, 3147, 3148, 3149, 3150, 3151, 3152, 3153, 3154, 3155, 3156, 3157, 3158, 3159, 3160, 3161, 3162, 3163, 3164, 3165, 3166, 3167, 3168, 3169, 3170, 3171, 3172, 3173, 3174, 3175, 3176, 3177, 3178, 3179, 3180, 3181, 3182, 3183, 3184, 3185, 3186, 3187, 3188, 3189, 3190, 3191, 3192, 3193, 3194, 3195, 3196, 3197, 3198, 3199, 3200, 3201, 3202, 3203, 3204, 3205, 3206, 3207, 3208, 3209, 3210, 3211, 3212, 3213, 3214, 3215, 3216, 3217, 3218, 3219, 3220, 3221, 3222, 3223, 3224, 3225, 3226, 3227, 3228, 3229, 3230, 3231, 3232, 3233, 3234, 3235, 3236, 3237, 3238, 3239, 3240, 3241, 3242, 3243, 3244, 3245, 3246, 3247, 3248, 3249, 3250, 3251, 3252, 3253, 3254, 3255, 3256, 3257, 3258, 3259, 3260, 3261, 3262, 3263, 3264, 3265, 3266, 3267, 3268, 3269, 3270, 3271, 3272, 3273, 3274, 3275, 3276, 3277, 3278, 3279, 3280, 3281, 3282, 3283, 3284, 3285, 3286, 3287, 3288, 3289, 3290, 3291, 3292, 3293, 3294, 3295, 3296, 3297, 3298, 3299, 3300, 3301, 3302, 3303, 3304, 3305, 3306, 3307, 3308, 3309, 3310, 3311, 3312, 3313, 3314, 3315, 3316, 3317, 3318, 3319, 3320, 3321, 3322, 3323, 3324, 3325, 3326, 3327, 3328, 3329, 3330, 3331, 3332, 3333, 3334, 3335, 3336, 3337, 3338, 3339, 3340, 3341, 3342, 3343, 3344, 3345, 3346, 3347, 3348, 3349, 3350, 3351, 3352, 3353, 3354, 3355, 3356, 3357, 3358, 3359, 3360, 3361, 3362, 3363, 3364, 3365, 3366, 3367, 3368, 3369, 3370, 3371, 3372, 3373, 3374, 3375, 3376, 3377, 3378, 3379, 3380, 3381, 3382, 3383, 3384, 3385, 3386, 3387, 3388, 3389, 3390, 3391, 3392, 3393, 3394, 3395, 3396, 3397, 3398, 3399, 3400, 3401, 3402, 3403, 3404, 3405, 3406, 3407, 3408, 3409, 3410, 3411, 3412, 3413, 3414, 3415, 3416, 3417, 3418, 3419, 3420, 3421, 3422, 3423, 3424, 3425, 3426, 3427, 3428, 3429, 3430, 3431, 3432, 3433, 3434, 3435, 3436, 3437, 3438, 3439, 3440, 3441, 3442, 3443, 3444, 3445, 3446, 3447, 3448, 3449, 3450, 3451, 3452, 3453, 3454, 3455, 3456, 3457, 3458, 3459, 3460, 3461, 3462, 3463, 3464, 3465, 3466, 3467, 3468, 3469, 3470, 3471, 3472, 3473, 3474, 3475, 3476, 3477, 3478, 3479, 3480, 3481, 3482, 3483, 3484, 3485, 3486, 3487, 3488, 3489, 3490, 3491, 3492, 3493, 3494, 3495, 3496, 3497, 3498, 3499, 3500, 3501, 3502, 3503, 3504, 3505, 3506, 3507, 3508, 3509, 3510, 3511, 3512, 3513, 3514, 3515, 3516, 3517, 3518, 3519, 3520, 3521, 3522, 3523, 3524, 3525, 3526, 3527, 3528, 3529, 3530, 3531, 3532, 3533, 3534, 3535, 3536, 3537, 3538, 3539, 3540, 3541, 3542, 3543, 3544, 3545, 3546, 3547, 3548, 3549, 3550, 3551, 3552, 3553, 3554, 3555, 3556, 3557, 3558, 3559, 3560, 3561, 3562, 3563, 3564, 3565, 3566, 3567, 3568, 3569, 3570, 3571, 3572, 3573, 3574, 3575, 3576, 3577, 3578, 3579, 3580, 3581, 3582, 3583, 3584, 3585, 3586, 3587, 3588, 3589, 3590, 3591, 3592, 3593, 3594, 3595, 3596, 3597, 3598, 3599, 3600, 3601, 3602, 3603, 3604, 3605, 3606, 3607, 3608, 3609, 3610, 3611, 3612, 3613, 3614, 3615, 3616, 3617, 3618, 3619, 3620, 3621, 3622, 3623, 3624, 3625, 3626, 3627, 3628, 3629, 3630, 3631, 3632, 3633, 3634, 3635, 3636, 3637, 3638, 3639, 3640, 3641, 3642, 3643, 3644, 3645, 3646, 3647, 3648, 3649, 3650, 3651, 3652, 3653, 3654, 3655, 3656, 3657, 3658, 3659, 3660, 3661, 3662, 3663, 3664, 3665, 3666, 3667, 3668, 3669, 3670, 3671, 3672, 3673, 3674, 3675, 3676, 3677, 3678, 3679, 3680, 3681, 3682, 3683, 3684, 3685, 3686, 3687, 3688, 3689, 3690, 3691, 3692, 3693, 3694, 3695, 3696, 3697, 3698, 3699, 3700, 3701, 3702, 3703, 3704, 3705, 3706, 3707, 3708, 3709, 3710, 3711, 3712, 3713, 3714, 3715, 3716, 3717, 3718, 3719, 3720, 3721, 3722, 3723, 3724, 3725, 3726, 3727, 3728, 3729, 3730, 3731, 3732, 3733, 3734, 3735, 3736, 3737, 3738, 3739, 3740, 3741, 3742, 3743, 3744, 3745, 3746, 3747, 3748, 3749, 3750, 3751, 3752, 3753, 3754, 3755, 3756, 3757, 3758, 3759, 3760, 3761, 3762, 3763, 3764, 3765, 3766, 3767, 3768, 3769, 3770, 3771, 3772, 3773, 3774, 3775, 3776, 3777, 3778, 3779, 3780, 3781, 3782, 3783, 3784, 3785, 3786, 3787, 3788, 3789, 3790, 3791, 3792, 3793, 3794, 3795, 3796, 3797, 3798, 3799, 3800, 3801, 3802, 3803, 3804, 3805, 3806, 3807, 3808, 3809, 3810, 3811, 3812, 3813, 3814, 3815, 3816, 3817, 3818, 3819, 3820, 3821, 3822, 3823, 3824, 3825, 3826, 3827, 3828, 3829, 3830, 3831, 3832, 3833, 3834, 3835, 3836, 3837, 3838, 3839, 3840, 3841, 3842, 3843, 3844, 3845, 3846, 3847, 3848, 3849, 3850, 3851, 3852, 3853, 3854, 3855, 3856, 3857, 3858, 3859, 3860, 3861, 3862, 3863, 3864, 3865, 3866, 3867, 3868, 3869, 3870, 3871, 3872, 3873, 3874, 3875, 3876, 3877, 3878, 3879, 3880, 3881, 3882, 3883, 3884, 3885, 3886, 3887, 3888, 3889, 3890, 3891, 3892, 3893, 3894, 3895, 3896, 3897, 3898, 3899, 3900, 3901, 3902, 3903, 3904, 3905, 3906, 3907, 3908, 3909, 3910, 3911, 3912, 3913, 3914, 3915, 3916, 3917, 3918, 3919, 3920, 3921, 3922, 3923, 3924, 3925, 3926, 3927, 3928, 3929, 3930, 3931, 3932, 3933, 3934, 3935, 3936, 3937, 3938, 3939, 3940, 3941, 3942, 3943, 3944, 3945, 3946, 3947, 3948, 3949, 3950, 3951, 3952, 3953, 3954, 3955, 3956, 3957, 3958, 3959, 3960, 3961, 3962, 3963, 3964, 3965, 3966, 3967, 3968, 3969, 3970, 3971, 3972, 3973, 3974, 3975, 3976, 3977, 3978, 3979, 3980, 3981, 3982, 3983, 3984, 3985, 3986, 3987, 3988, 3989, 3990, 3991, 3992, 3993, 3994, 3995, 3996, 3997, 3998, 3999, 4000 CFM (Cubic Feet per Minute), and/or combination thereof.

In some aspects, the techniques described herein may relate to system filter units that may filter large-scale purification and/or may be designed for airflow capacities ranging from 1500 to 4000 CFM but may be scaled further using parallel fans, for example, up to 8000 CFM. For example, 1500, 1600, 1700, 1800, 1900, 2000, 2100, 2200, 2300, 2400, 2500, 2600, 2700, 2800, 2900, 3000, 3100, 3200, 3300, 3400, 3500, 3600, 3700, 3800, 3900, 4000, 4100, 4200, 4300, 4400, 4500, 4600, 4700, 4800, 4900, 5000, 5100, 5200, 5300, 5400, 5500, 5600, 5700, 5800, 5900, 6000, 6100, 6200, 6300, 6400, 6500, 6600, 6700, 6800, 6900, 7000, 7100, 7200, 7300, 7400, 7500, 7600, 7700, 7800, 7900, 8000 CFM, and/or any combination thereof.

In some aspects, the techniques described herein may relate to system filter units that may have a coverage of 90,000-240,000 cubic feet/hour and/or may be suitable for outdoor areas of 1500-2000 square feet. However, the fans (or equivalents) may be arranged parallel and/or sequentially for higher airflow. For example, 90000, 90500, 91000, 91500, 92000, 92500, 93000, 93500, 94000, 94500, 95000, 95500, 96000, 96500, 97000, 97500, 98000, 98500, 99000, 99500, 100000, 100500, 101000, 101500, 102000, 102500, 103000, 103500, 104000, 104500, 105000, 105500, 106000, 106500, 107000, 107500, 108000, 108500, 109000, 109500, 110000, 110500, 111000, 111500, 112000, 112500, 113000, 113500, 114000, 114500, 115000, 115500, 116000, 116500, 117000, 117500, 118000, 118500, 119000, 119500, 120000, 120500, 121000, 121500, 122000, 122500, 123000, 123500, 124000, 124500, 125000, 125500, 126000, 126500, 127000, 127500, 128000, 128500, 129000, 129500, 130000, 130500, 131000, 131500, 132000, 132500, 133000, 133500, 134000, 134500, 135000, 135500, 136000, 136500, 137000, 137500, 138000, 138500, 139000, 139500, 140000, 140500, 141000, 141500, 142000, 142500, 143000, 143500, 144000, 144500, 145000, 145500, 146000, 146500, 147000, 147500, 148000, 148500, 149000, 149500, 150000, 150500, 151000, 151500, 152000, 152500, 153000, 153500, 154000, 154500, 155000, 155500, 156000, 156500, 157000, 157500, 158000, 158500, 159000, 159500, 160000, 160500, 161000, 161500, 162000, 162500, 163000, 163500, 164000, 164500, 165000, 165500, 166000, 166500, 167000, 167500, 168000, 168500, 169000, 169500, 170000, 170500, 171000, 171500, 172000, 172500, 173000, 173500, 174000, 174500, 175000, 175500, 176000, 176500, 177000, 177500, 178000, 178500, 179000, 179500, 180000, 180500, 181000, 181500, 182000, 182500, 183000, 183500, 184000, 184500, 185000, 185500, 186000, 186500, 187000, 187500, 188000, 188500, 189000, 189500, 190000, 190500, 191000, 191500, 192000, 192500, 193000, 193500, 194000, 194500, 195000, 195500, 196000, 196500, 197000, 197500, 198000, 198500, 199000, 199500, 200000, 200500, 201000, 201500, 202000, 202500, 203000, 203500, 204000, 204500, 205000, 205500, 206000, 206500, 207000, 207500, 208000, 208500, 209000, 209500, 210000, 210500, 211000, 211500, 212000, 212500, 213000, 213500, 214000, 214500, 215000, 215500, 216000, 216500, 217000, 217500, 218000, 218500, 219000, 219500, 220000, 220500, 221000, 221500, 222000, 222500, 223000, 223500, 224000, 224500, 225000, 225500, 226000, 226500, 227000, 227500, 228000, 228500, 229000, 229500, 230000, 230500, 231000, 231500, 232000, 232500, 233000, 233500, 234000, 234500, 235000, 235500, 236000, 236500, 237000, 237500, 238000, 238500, 239000, 239500, 240000 cubic feet/hour, and/or any combination thereof.

In some aspects, the techniques described herein may relate to the fans (or equivalents) may be arranged parallel and/or sequentially for higher airflow 1500, 1501, 1502, 1503, 1504, 1505, 1506, 1507, 1508, 1509, 1510, 1511, 1512, 1513, 1514, 1515, 1516, 1517, 1518, 1519, 1520, 1521, 1522, 1523, 1524, 1525, 1526, 1527, 1528, 1529, 1530, 1531, 1532, 1533, 1534, 1535, 1536, 1537, 1538, 1539, 1540, 1541, 1542, 1543, 1544, 1545, 1546, 1547, 1548, 1549, 1550, 1551, 1552, 1553, 1554, 1555, 1556, 1557, 1558, 1559, 1560, 1561, 1562, 1563, 1564, 1565, 1566, 1567, 1568, 1569, 1570, 1571, 1572, 1573, 1574, 1575, 1576, 1577, 1578, 1579, 1580, 1581, 1582, 1583, 1584, 1585, 1586, 1587, 1588, 1589, 1590, 1591, 1592, 1593, 1594, 1595, 1596, 1597, 1598, 1599, 1600, 1601, 1602, 1603, 1604, 1605, 1606, 1607, 1608, 1609, 1610, 1611, 1612, 1613, 1614, 1615, 1616, 1617, 1618, 1619, 1620, 1621, 1622, 1623, 1624, 1625, 1626, 1627, 1628, 1629, 1630, 1631, 1632, 1633, 1634, 1635, 1636, 1637, 1638, 1639, 1640, 1641, 1642, 1643, 1644, 1645, 1646, 1647, 1648, 1649, 1650, 1651, 1652, 1653, 1654, 1655, 1656, 1657, 1658, 1659, 1660, 1661, 1662, 1663, 1664, 1665, 1666, 1667, 1668, 1669, 1670, 1671, 1672, 1673, 1674, 1675, 1676, 1677, 1678, 1679, 1680, 1681, 1682, 1683, 1684, 1685, 1686, 1687, 1688, 1689, 1690, 1691, 1692, 1693, 1694, 1695, 1696, 1697, 1698, 1699, 1700, 1701, 1702, 1703, 1704, 1705, 1706, 1707, 1708, 1709, 1710, 1711, 1712, 1713, 1714, 1715, 1716, 1717, 1718, 1719, 1720, 1721, 1722, 1723, 1724, 1725, 1726, 1727, 1728, 1729, 1730, 1731, 1732, 1733, 1734, 1735, 1736, 1737, 1738, 1739, 1740, 1741, 1742, 1743, 1744, 1745, 1746, 1747, 1748, 1749, 1750, 1751, 1752, 1753, 1754, 1755, 1756, 1757, 1758, 1759, 1760, 1761, 1762, 1763, 1764, 1765, 1766, 1767, 1768, 1769, 1770, 1771, 1772, 1773, 1774, 1775, 1776, 1777, 1778, 1779, 1780, 1781, 1782, 1783, 1784, 1785, 1786, 1787, 1788, 1789, 1790, 1791, 1792, 1793, 1794, 1795, 1796, 1797, 1798, 1799, 1800, 1801, 1802, 1803, 1804, 1805, 1806, 1807, 1808, 1809, 1810, 1811, 1812, 1813, 1814, 1815, 1816, 1817, 1818, 1819, 1820, 1821, 1822, 1823, 1824, 1825, 1826, 1827, 1828, 1829, 1830, 1831, 1832, 1833, 1834, 1835, 1836, 1837, 1838, 1839, 1840, 1841, 1842, 1843, 1844, 1845, 1846, 1847, 1848, 1849, 1850, 1851, 1852, 1853, 1854, 1855, 1856, 1857, 1858, 1859, 1860, 1861, 1862, 1863, 1864, 1865, 1866, 1867, 1868, 1869, 1870, 1871, 1872, 1873, 1874, 1875, 1876, 1877, 1878, 1879, 1880, 1881, 1882, 1883, 1884, 1885, 1886, 1887, 1888, 1889, 1890, 1891, 1892, 1893, 1894, 1895, 1896, 1897, 1898, 1899, 1900, 1901, 1902, 1903, 1904, 1905, 1906, 1907, 1908, 1909, 1910, 1911, 1912, 1913, 1914, 1915, 1916, 1917, 1918, 1919, 1920, 1921, 1922, 1923, 1924, 1925, 1926, 1927, 1928, 1929, 1930, 1931, 1932, 1933, 1934, 1935, 1936, 1937, 1938, 1939, 1940, 1941, 1942, 1943, 1944, 1945, 1946, 1947, 1948, 1949, 1950, 1951, 1952, 1953, 1954, 1955, 1956, 1957, 1958, 1959, 1960, 1961, 1962, 1963, 1964, 1965, 1966, 1967, 1968, 1969, 1970, 1971, 1972, 1973, 1974, 1975, 1976, 1977, 1978, 1979, 1980, 1981, 1982, 1983, 1984, 1985, 1986, 1987, 1988, 1989, 1990, 1991, 1992, 1993, 1994, 1995, 1996, 1997, 1998, 1999, 2000 square feet, and/or any combination thereof.

In some aspects, the techniques described herein may relate to a system building fixable system to one or more buildings; for example, the system may be attached and/or mounted on building/s.

In some aspects, the techniques described herein may relate to one or more parts of the housing module that may be detachably attached. One or more parts of housing modules may be replaced manually and/or/or automatically, etc., and/or any combination thereof.

### EXAMPLE MATERIAL LIST

| Component | Material |
|---|---|
| Housing | Stainless steel, powder-coated steel |
| Intake Funnel/Grille | HDPE, stainless steel mesh |
| Pre-Filter | Synthetic fibers, aluminum mesh |
| HEPA Filter | Borosilicate glass fibers |
| Carbon Filter | Coconut shell-based activated carbon |
| Fan Blades/equivalent | Aluminum |
| Bearings | Stainless steel, Teflon-coated |
| Solar Panels | Monocrystalline silicon |
| Monitoring Sensors | PCB boards with protective coatings |
| UV Tubes | Quartz |

### DETAILED DESCRIPTION OF THE FIGURES

The present invention's various embodiments will be described in conjunction with the appended drawings, wherein like designations denote like elements.

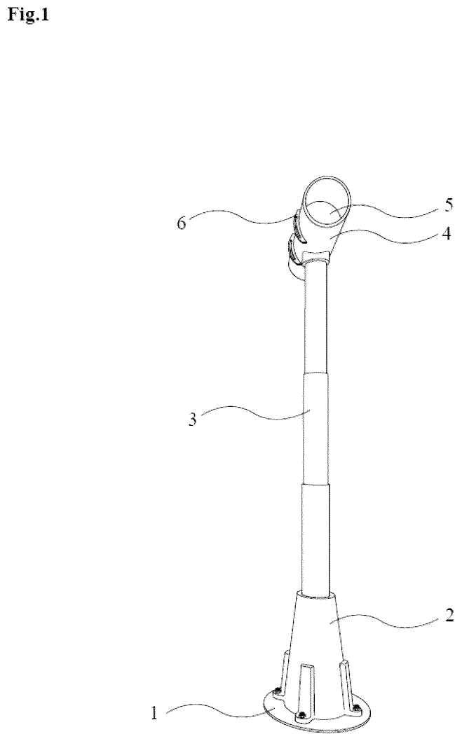

The drawings are referred to by numerals, as shown in FIGS. 1-7, an air purification system having the following components: Cement Base Anchor 1—Holds Air Purification System in place; Air Purification Base 2—Bottom metal base that connects upper poles/Possible elevator access to reach upper sections; Middle Support Pole 3—Supports air purification system on top; Air Purification Housing module 4—Holds interior filtration pieces; Carbon Filter 5—Purifies and/or cleans bad air; Carbon Filter Housing 6—Metal housing that holds filter in place; and/or Vacuum Fan 7—Pulls in the bad air to be filtered and/or cleaned.

FIG. 1 shows a front view illustrating an air purification system according to an embodiment of the present invention. The air purification system has the following components: Base anchor [1] holds the air purification system in place and/or anchors the system to the ground and/or/or another structure, such as a building. It may be made of cement, metal, metal alloy, plastic, etc., and/or/or any combination thereof. An air purification base [2] is a bottom base made of a metal, metal alloy, cement, plastic, etc., and/or/or any combination thereof. It connects upper air purification system components through the poles [3]. It possibly may have elevator access to reach the upper sections. The support pole may be extendable and may have length modulable/adjustable mechanisms, so the system's height may be changeable and/or provide support for the air purification system on top. The air purification housing module [4] holds interior filtration pieces such as one or more carbon and/or/or other filters [5] that purify and/or clean bad air. Filter housing module [4] may contain one or more filters [6], such as carbon, and/or the housing module may hold the filter in place; it may be made of cement, metal, metal alloy, plastic, etc., and/or/or any combination thereof. The filters may be accessible outside [6] and/or/or inside (not shown herein). The system contains one or more of the air suction mechanisms [7] that may have one or more single-stage high-performance turbines, dual turbines, multi-stage turbine systems (more than two stages), centrifugal blowers, regenerative blowers (ring blowers), positive displacement blowers, axial fans, hybrid cyclonic systems, and/or any combination thereof. The air suction mechanism [7] acts as a vacuum fan and/or may pull in the bad air to be filtered and/or cleaned.

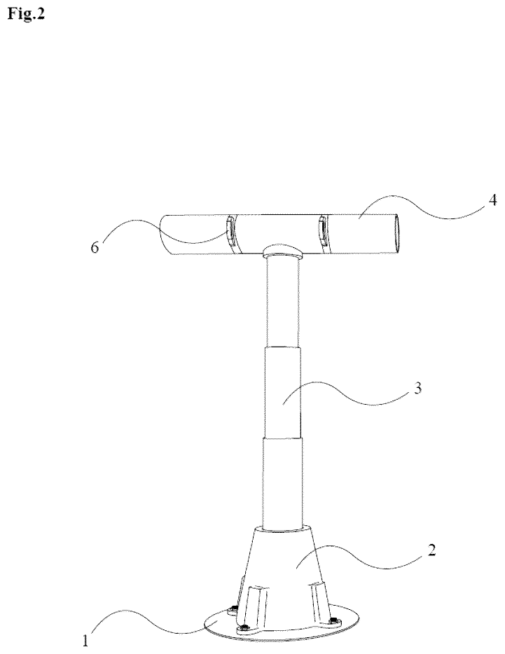

FIG. 2 is a side view illustrating the air purification system according to an embodiment of the present invention of FIG. 1. This view shows a base anchor [1] that holds the air purification system in place and/or anchors the system to the ground and/or/or another structure, such as a building. An air purification base [2] is a bottom base that connects upper air purification system components through the poles [3]. The support pole may be extendable and/or have length modulable/adjustable mechanisms, so the system's height may be changeable and/or provide support for the air purification system on top. It may be a solid or hollow pole; it may have stairs, an elevator, electronics, etc., and/or any combination inside the hollow interior and/or/or attached to the outside of the pole. The air purification housing module [4] holds interior filtration pieces such as one or more carbon and/or/or other filters [5] that purify and/or clean bad air. Filter housing module [4] may contain one or more filters [6], such as carbon, HEPA filters (high-efficiency particulate air), pre-filters, ULPA filters (ultra-low penetration air), electrostatic filtration, electrostatic precipitators, ionizers, activated carbon filtration, UV-C light purification, photocatalytic oxidation (PCO), ozone generators, biological filtration, biofilters, plasma air purification, thermal oxidation, ozone destructive catalyst, hybrid systems, premax pre-filter, potassium permanganate impregnated media, 3D ultra seal technology, advanced fan technology and/or any combination thereof. The housing module may hold the filter in place. The filters may be accessible outside [6] and/or/or inside (not shown herein).

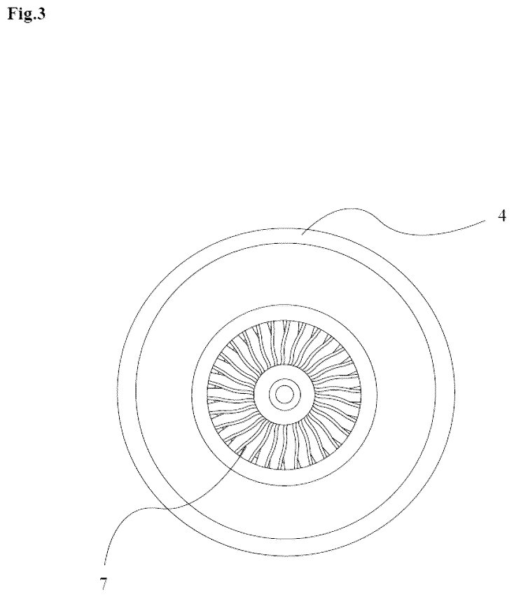

FIG. 3 is a front view illustrating the air purification housing module according to an embodiment of the present invention of FIG. 1. The housing module [4] may hold the air suction mechanisms [7] that may have one or more single-stage high-performance turbines, dual turbines, multi-stage turbine systems (more than two stages), centrifugal blowers, regenerative blowers (ring blowers), positive displacement blowers, axial fans, hybrid cyclonic systems, and/or any combination thereof. The air suction mechanism [7] acts as a vacuum fan and/or may pull in the bad air to be filtered and/or cleaned. Behind the suction mechanism are one or more filters not shown in this view.

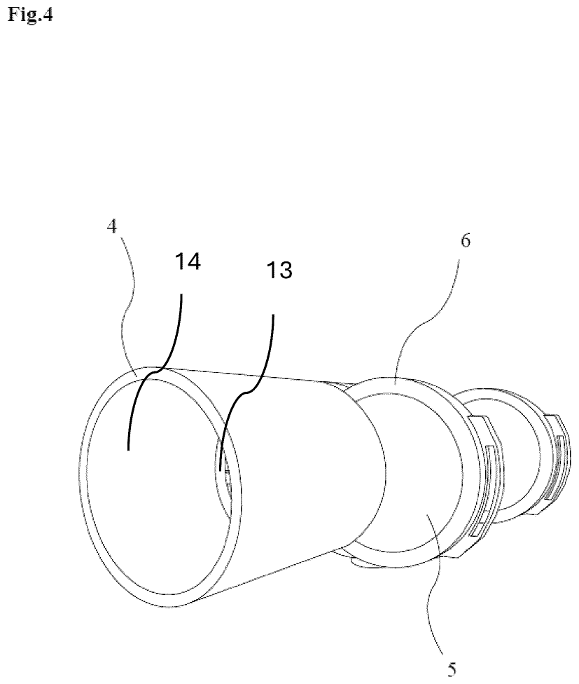

FIG. 4 is a perspective side view illustrating the housing module of an air purification system according to an embodiment of the present invention of FIG. 1. The housing module [4] may hold filtration pieces such as one or more carbon and/or/or other filters [5] that purify and/or clean bad air. Filter housing module [4] may contain one or more filters [6], such as carbon, HEPA filters (high-efficiency particulate air), pre-filters, ULPA filters (ultra-low penetration air), electrostatic filtration, electrostatic precipitators, ionizers, activated carbon filtration, UV-C light purification, photocatalytic oxidation (PCO), ozone generators, biological filtration, biofilters, plasma air purification, thermal oxidation, ozone destructive catalyst, hybrid systems, premax pre-filter, potassium permanganate impregnated media, 3D ultra seal technology, advanced fan technology and/or any combination thereof. The housing module may hold the filter in place. The filters may be accessible from outside [6] and/or/or inside [14]. The filters may be covered with protective grilles, diverters, and/or pre-filters to block large debris [13].

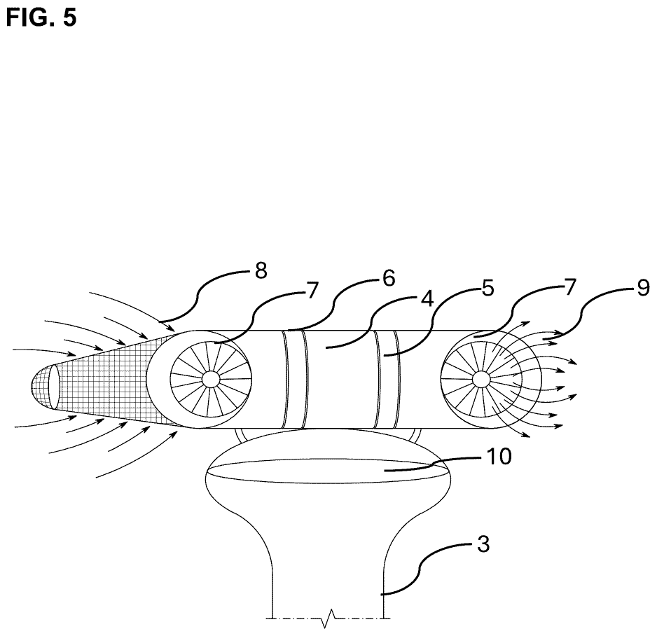

FIG. 5 is a side view illustrating the air purification housing with the swiveling platform with a 360-degree multidirectional movement mechanism according to an embodiment of the present invention of FIG. 1. The swiveling mechanism is mounted on the pole [3]. On the top of the swiveling platform is the air purification housing module. The housing module may have one or more suction mechanisms [7] that may have two parts: one air intake [8] and another air-pushed-out component [9]. The polluted or dirty air is sucked in [8], and/or after filtration from one or more filters [5]; in this example, two filters and clean air may be pushed out [9]. The filters may be fitted with protective grilles and/or pre-filter.

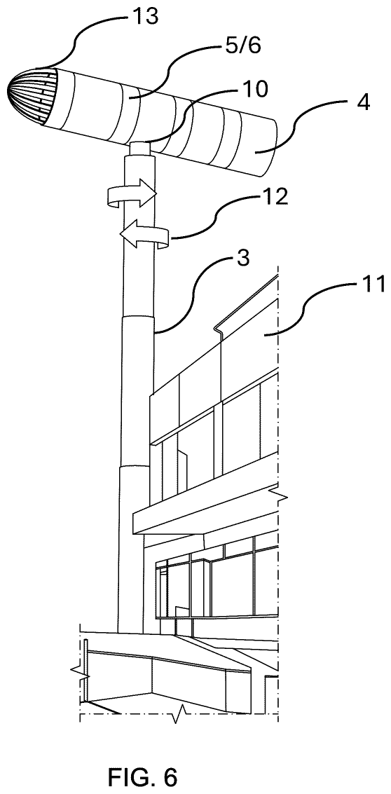

FIG. 6 is a side view illustrating the air purification system attached to a building according to an embodiment of the present invention of FIG. 1. The air purification system may be free-standing and/or/or attached to other structures such as residential buildings, including single-family homes, apartments, townhouses, duplexes, villas, condominiums, commercial buildings, such as office complexes, shopping malls, hotels, restaurants, banks, and/or supermarkets, industrial buildings, like factories, warehouses, power plants, oil refineries, research laboratories, public and/or institutional structures, including schools, universities, hospitals, libraries, museums, community centers, and/or government offices, cater to educational, healthcare, civic needs, religious buildings, such as churches, mosques, temples, synagogues, and/or monasteries, leisure and/or recreation, structures like stadiums, theaters, parks, aquariums, zoos, infrastructure and/or utility buildings, including bridges, dams, tunnels, airports, train stations, unique and/or specialty structures, such as skyscrapers, green buildings, historical landmarks, fwindmills, loating buildings, etc., and/or any combination thereof. The housing module in this example has three filters [5/6] and/or one protective grill and/or/or pre-filter [13]. Behing this protective grill, may be suction mechanism (not shown). The system may swivel in one or more directions up to 360 degrees; for example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 291, 292, 293, 294, 295, 296, 297, 298, 299, 300, 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 348, 349, 350, 351, 352, 353, 354, 355, 356, 357, 358, 359, 360 degrees, and/or any combination thereof.

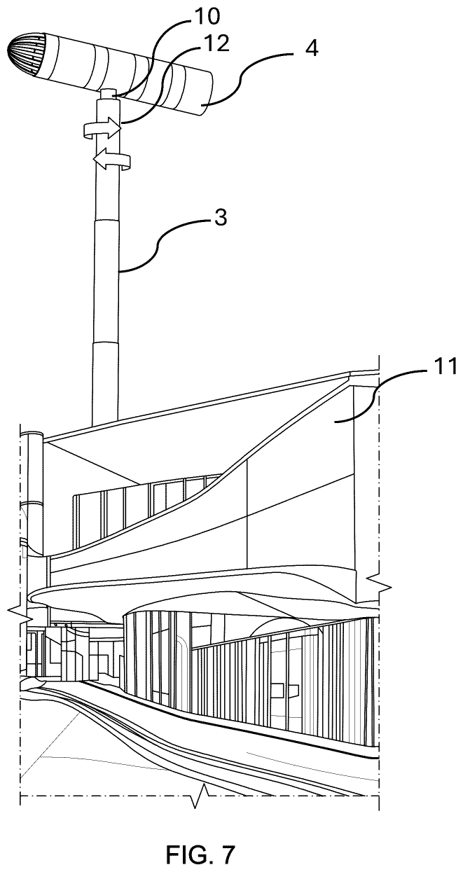

FIG. 7 is a side view illustrating the air purification system mounted on top of a building according to an embodiment of the present invention of FIG. 1. The air purification system may be free-standing and/or attached to other structures such as residential buildings, including single-family homes, apartments, townhouses, duplexes, villas, condominiums, commercial buildings, such as office complexes, shopping malls, hotels, restaurants, banks, supermarkets, industrial buildings, like factories, warehouses, power plants, oil refineries, research laboratories, public and/or institutional structures, including schools, universities, hospitals, libraries, museums, community centers, and/or government offices, cater to educational, healthcare, civic needs, religious buildings, such as churches, mosques, temples, synagogues, and/or monasteries, leisure and/or recreation, structures like stadiums, theaters, parks, aquariums, zoos, infrastructure and/or utility buildings, including bridges, dams, tunnels, airports, train stations, unique and/or specialty structures, such as skyscrapers, green buildings, historical landmarks, windmills, floating buildings, etc., and/or any combination thereof. The system may swivel in one or more directions up to 360 degrees; for example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 291, 292, 293, 294, 295, 296, 297, 298, 299, 300, 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 348, 349, 350, 351, 352, 353, 354, 355, 356, 357, 358, 359, 360 degrees, and/or any combination thereof. In some aspects, the techniques described herein may relate to the support pole [3], which may be from zero (no pole) to 1000 feet tall. For example, 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 291, 292, 293, 294, 295, 296, 297, 298, 299, 300, 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 348, 349, 350, 351, 352, 353, 354, 355, 356, 357, 358, 359, 360, 361, 362, 363, 364, 365, 366, 367, 368, 369, 370, 371, 372, 373, 374, 375, 376, 377, 378, 379, 380, 381, 382, 383, 384, 385, 386, 387, 388, 389, 390, 391, 392, 393, 394, 395, 396, 397, 398, 399, 400, 401, 402, 403, 404, 405, 406, 407, 408, 409, 410, 411, 412, 413, 414, 415, 416, 417, 418, 419, 420, 421, 422, 423, 424, 425, 426, 427, 428, 429, 430, 431, 432, 433, 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 501, 502, 503, 504, 505, 506, 507, 508, 509, 510, 511, 512, 513, 514, 515, 516, 517, 518, 519, 520, 521, 522, 523, 524, 525, 526, 527, 528, 529, 530, 531, 532, 533, 534, 535, 536, 537, 538, 539, 540, 541, 542, 543, 544, 545, 546, 547, 548, 549, 550, 551, 552, 553, 554, 555, 556, 557, 558, 559, 560, 561, 562, 563, 564, 565, 566, 567, 568, 569, 570, 571, 572, 573, 574, 575, 576, 577, 578, 579, 580, 581, 582, 583, 584, 585, 586, 587, 588, 589, 590, 591, 592, 593, 594, 595, 596, 597, 598, 599, 600, 601, 602, 603, 604, 605, 606, 607, 608, 609, 610, 611, 612, 613, 614, 615, 616, 617, 618, 619, 620, 621, 622, 623, 624, 625, 626, 627, 628, 629, 630, 631, 632, 633, 634, 635, 636, 637, 638, 639, 640, 641, 642, 643, 644, 645, 646, 647, 648, 649, 650, 651, 652, 653, 654, 655, 656, 657, 658, 659, 660, 661, 662, 663, 664, 665, 666, 667, 668, 669, 670, 671, 672, 673, 674, 675, 676, 677, 678, 679, 680, 681, 682, 683, 684, 685, 686, 687, 688, 689, 690, 691, 692, 693, 694, 695, 696, 697, 698, 699, 700, 701, 702, 703, 704, 705, 706, 707, 708, 709, 710, 711, 712, 713, 714, 715, 716, 717, 718, 719, 720, 721, 722, 723, 724, 725, 726, 727, 728, 729, 730, 731, 732, 733, 734, 735, 736, 737, 738, 739, 740, 741, 742, 743, 744, 745, 746, 747, 748, 749, 750, 751, 752, 753, 754, 755, 756, 757, 758, 759, 760, 761, 762, 763, 764, 765, 766, 767, 768, 769, 770, 771, 772, 773, 774, 775, 776, 777, 778, 779, 780, 781, 782, 783, 784, 785, 786, 787, 788, 789, 790, 791, 792, 793, 794, 795, 796, 797, 798, 799, 800, 801, 802, 803, 804, 805, 806, 807, 808, 809, 810, 811, 812, 813, 814, 815, 816, 817, 818, 819, 820, 821, 822, 823, 824, 825, 826, 827, 828, 829, 830, 831, 832, 833, 834, 835, 836, 837, 838, 839, 840, 841, 842, 843, 844, 845, 846, 847, 848, 849, 850, 851, 852, 853, 854, 855, 856, 857, 858, 859, 860, 861, 862, 863, 864, 865, 866, 867, 868, 869, 870, 871, 872, 873, 874, 875, 876, 877, 878, 879, 880, 881, 882, 883, 884, 885, 886, 887, 888, 889, 890, 891, 892, 893, 894, 895, 896, 897, 898, 899, 900, 901, 902, 903, 904, 905, 906, 907, 908, 909, 910, 911, 912, 913, 914, 915, 916, 917, 918, 919, 920, 921, 922, 923, 924, 925, 926, 927, 928, 929, 930, 931, 932, 933, 934, 935, 936, 937, 938, 939, 940, 941, 942, 943, 944, 945, 946, 947, 948, 949, 950, 951, 952, 953, 954, 955, 956, 957, 958, 959, 960, 961, 962, 963, 964, 965, 966, 967, 968, 969, 970, 971, 972, 973, 974, 975, 976, 977, 978, 979, 980, 981, 982, 983, 984, 985, 986, 987, 988, 989, 990, 991, 992, 993, 994, 995, 996, 997, 998, 999, 1000, and any combination thereof feet tall.

It should be noted that the steps described in the method of use can be carried out in many different orders according to user preference. The use of “step of” should not be interpreted as “step for”, in the claims herein and/or is not intended to invoke the provisions of 35 U.S.C. § 112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and/or numerous modifications, variations and/or rearrangements can be readily envisioned to achieve substantially equivalent results, all of which are intended to be embraced within the spirit and/or scope of the invention. Further, the purpose of the foregoing abstract is to enable the U.S. Patent and/or Trademark Office and/or the public generally, and/or especially the scientist, engineers and/or practitioners in the art who are not familiar with patent or legal terms or phraseology, to determine quickly from a cursory inspection the nature and/or essence of the technical disclosure of the application.

It is to be understood that the above description is intended to be illustrative and/or not restrictive. For example, the above-described embodiments (and/or aspects thereof) may be used in combination with each other. In addition, many modifications may be made to adapt a particular situation, method, system device, or material to the teachings of the various embodiments of the invention without departing from their scope. While the particulars and details described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements or steps that do not differ from the literal language of the claims, or if the examples include equivalent structural elements or steps with insubstantial differences from the literal language of the claim.

1. An air purification system comprising: a base, a middle support pole, and an air purifier, wherein the base further comprising of a base-anchor and a base-bottom, wherein the middle support pole is configured to connect the base to the air purifier, wherein the air purifier comprising of at least one housing module, at least one filtering unit, at least one air suction unit, and at least one swiveling platform with up to 360-degree multidirectional movement mechanism, wherein the air suction unit is configured to pulls air through the filtering unit for air purification.

2. The system of claim 1, wherein the base-anchor comprises cement.

3. The system of claim 1, wherein the base-bottom comprises of metal.

4. The system of claim 1, wherein the base-bottom comprises elevator access.

5. The system of claim 1, wherein the middle support pole comprising of one or more of length modulable/adjustable mechanism selected from a group consisting of telescopic design, segmented pole with screw or snap joints, expandable lattice, scissor mechanism, stackable sections with interlocking mechanism, cable and sleeve design, magnetic or clip-on modules, and any combination thereof.

6. The system of claim 1, wherein the system is from 10 to 600 feet tall.

7. The system of claim 1, wherein the system further comprises a wind-tracking mechanism, wherein the wind-tracking mechanism is configured to ensure the air suction unit faces prevailing wind direction, wherein the wind-tracking mechanism selected from a group consisting of a swiveling base, wind vane, motorized alignment system, and any combination thereof.

8. The system of claim 1, wherein one or more of the at least one swiveling platform with the 360-degree multidirectional movement mechanism is selected from a group consisting of a rotating platform, omnidirectional swirl device, propeller or nozzle-based device, swiveling head, swivel bearing, rotating bracket, turntable swivel plate, motorized swivels, swiveling base with bearings and any combination of thereof.

9. The system of claim 1, wherein at least one swiveling platform with the 360-degree multidirectional movement mechanism is linked to the housing module, wherein the housing module comprising of one or more wind direction sensor/s, and wherein the wind direction sensor/s and the 360-degree multidirectional movement mechanism is configured to move the housing module in the direction of the wind.

10. The system of claim 1, wherein the at least one swiveling platform with the 360-degree multidirectional movement mechanism is lockable-unlockable.

11. The system of claim 1, wherein the housing module further comprises wind sensors selected from a group consisting of motorized wind trackers, anemometers, cup anemometers, vane anemometers, hot-wire anemometers, thermal anemometers, ultrasonic sensors, pressure-based sensors, thermal flow sensors, optical sensors, mechanical sensors, MEMS (Micro-Electro-Mechanical) sensors, wind profiler, radar or acoustic signals, multi-hole probes, doppler radar, LIDAR (Light Detection and Ranging) systems, pitot tubes, motion sensors, tilt sensors, and any combination thereof.

12. The system of claim 1, wherein one or more of the air suction unit is configured to have a suction mechanism, wherein the suction mechanism is selected from a group consisting of single-stage high-performance turbines, dual turbines, multi-stage turbine systems, multi-stage turbine systems with more than two stages, centrifugal blowers, regenerative blowers, ring blowers, positive displacement blowers, axial fans, hybrid cyclonic systems, and any combination thereof.

13. The system of claim 1, wherein the air suction unit comprises a front end configured for air intake and a back end configured to push air out, and wherein the filtering unit is configured to be sandwiched between the front end and the back end for air purification.

14. The system of claim 1, wherein the filtering unit comprises at least one carbon filter.

15. The system of claim 1, wherein the filtering unit comprising one or more selected from a group consisting of HEPA filters (high-efficiency particulate air), pre-filters, ULPA filters (ultra-low penetration air), electrostatic filtration, electrostatic precipitators, ionizers, activated carbon filtration, UV-C light purification, photocatalytic oxidation (PCO), ozone generators, biological filtration, biofilters, plasma air purification, thermal oxidation, ozone destructive catalyst, hybrid systems, premax pre-filter, potassium permanganate impregnated media, 3D ultra seal technology, advanced fan technology and any combination thereof.

16. The system of claim 1, wherein the filtration unit purifies air contaminates, wherein the air contaminates are from one or more selected from a group consisting of dust, particles of 0.003 microns, PM10, particles ≤10 microns, PM2.5 particles ≤2.5 microns, PM1 particles ≤1 micron, allergens, pollen, pet dander, mold spores, dust mites, biological contaminates, viruses, bacteria, mold, fungi, gaseous pollutants, volatile organic compounds (VOCs), paint emitters, solvents, cleaning agents, building materials, carbon monoxide (CO), nitrogen dioxide (NO₂), vehicle emitters, industrial emitters, sulfur dioxide (SO₂), smoke, odor, cooking emitters, pet odors, smoke, soot, chemical pollutants, formaldehyde, ammonia, chlorine gases, heavy metals, lead, cadmium, mercury, radon, ozone, and any combination thereof.

17. The system of claim 1, wherein the housing module further comprises a sieving mechanism, wherein the sieving mechanism is configured to prevent birds and other large materials from entering the air purifier.

18. The system of claim 1, wherein the housing module comprises a light.

19. The system of claim 1, wherein the housing module is dome-shaped.

20. The system of claim 1, wherein the system is powered by one or more selected from a group consisting of solar power, wind-powered, battery, electricity, and any combination thereof.

21. The system of claim 1, wherein the filter units cover up to 2000 square feet.

22. The system of claim 1, wherein the purifier filters air from 11,000 to 350,000 cubic feet per hour.

23. The system of claim 1, wherein the system is fixable on at least one building.

24. The system of claim 1, wherein the system further comprises a control panel, wherein the control panel is configured to regulate one or more system parts, wherein the control panel is customizably programmable, and wherein the control panel location is selected from one or more selected from a group consisting of the base, the middle support pole, the air purifier, remotely, an APP, and any combination thereof.

25. The control panel of claim 24, wherein the control panel is configured to regulate one or more selected from a group consisting of the middle pole height, suction levels, filtration levels, filtration type, the swivel mechanism, swivel direction, swivel amount, air suction, and any combination thereof.
